(19) United States
(12) Patent Application Publication
(10) Pub. No.: US 2020/0054013 A1
(43) Pub. Date: Feb. 20, 2020

(54) SEED TREATMENT COMPOSITIONS

(71) Applicant: Monsanto Technology LLC, St. Louis, MO (US)

(72) Inventors: Patrick Callaghan Boyle, Chesterfield, MO (US); Ron Colletti, Wildwood, MO (US); Yiwei Ding, Creve Coeur, MO (US); Hui Han, Chesterfield, MO (US); David A. Morgenstern, St. Louis, MO (US); David Przybyla, O'Fallon, MO (US); Daniel James Seyer, Ballwin, MO (US); Hadi ShamsiJazeyi, Chesterfield, MO (US)

(73) Assignee: Monsanto Technology LLC, St. Louis, MO (US)

(21) Appl. No.: 16/487,705

(22) PCT Filed: Feb. 22, 2018
(86) PCT No.: PCT/US2018/019101

§ 371 Date: Aug. 21, 2019

Related U.S. Application Data
(60) Provisional application No. 62/462,135, filed on Feb. 22, 2017.

(51) Int. Cl. A01N 43/82; A01C 1/06; A01N 25/24

(52) U.S. Cl. CPC A01N 43/82; A01N 25/24; A01C 1/06

(57) ABSTRACT

Provided herein are compositions and methods for inhibiting the sublimation of solid compounds, such as 3,5-disubstituted-1,2,4-oxadiazoles, from the surface of a substrate (e.g., seeds).

### FIELD

Provided herein are methods for inhibiting the sublimation of solid compounds, such as 3,5-disubstituted-1,2,4-oxadiazoles, from the surface of a substrate (e.g., seeds).

### BACKGROUND

Sublimation is the transition of a substance directly from the solid to the gas phase without passing through the intermediate liquid phase. In applying compounds to a substrate, the applied solid compound can directly transition to the gas phase, i.e. sublime. There is an urgent need in the industry for controlling and/or inhibiting sublimation of a solid compound on a substrate.

For example, a class of 3,5-disubstituted-1,2,4-oxadiazoles has been shown to exhibit potent, broad spectrum nematicidal activity. See generally U.S. Pat. Nos. 8,435,999 and 8,017,555, the contents of which are expressly incorporated herein by reference. The 3,5-disubstituted-1,2,4-oxadiazoles disclosed in U.S. Pat. Nos. 8,435,999 and 8,017,555 are generally characterized by low water solubility.

Two-phase suspension concentrate compositions, which comprise solid particles of the 3,5-disubstituted-1,2,4-oxadiazole compounds suspended in an aqueous medium, are generally disclosed in U.S. Patent Application Publication Nos. 2014/0187419 A1 and 2015/0342189 A1, the contents of which are expressly incorporated herein by reference. Recently, it has been observed that in some cases, seed coatings comprising the 3,5-disubstituted-1,2,4-oxadiazoles and related compounds disclosed in U.S. Pat. Nos. 8,435,999 and 8,017,555 may develop an irregular and unattractive appearance over time. There is a need in the art to develop a solution that enables the efficient use of the above-mentioned 3,5-disubstituted-1,2,4-oxadiazole compounds in large-scale, commercial agricultural applications, particularly in seed treatment applications, to protect against nematode infestations.

### SUMMARY

Provided herein is a method of preparing a treated seed, the method comprising mixing a nematicidal composition comprising a 3,5-disubstituted 1,2,4-oxadiazole with a sublimation inhibitor to form a seed treatment mixture and applying the seed treatment mixture to a seed.

Also provided herein is a method of preparing a treated seed, the method comprising applying a first seed treatment mixture comprising a nematicidal composition comprising a 3,5-disubstituted 1,2,4-oxadiazole to a seed, and applying a second seed treatment mixture comprising a sublimation inhibitor to the seed to form a treated seed.

Also provided herein is a seed treatment mixture comprising a 3,5-disubstituted 1,2,4-oxadiazole and a sublimation inhibitor.

Also provided herein is a treated seed prepared according to a method as described herein.

Also provided herein is a method of inhibiting the sublimation of a solid compound from the surface of a substrate, the method comprising coating or contacting the solid compound with a treatment composition comprising a sublimation inhibitor as described herein.

In these and other embodiments, the sublimation inhibitor comprises a polymer selected from the group consisting of acrylic polymers, vinyl polymers, alkyl naphthalene sulfonates, sulfonate condensates, lignin sulfonates and mixtures thereof.

Other objects and features will be in part apparent and in part pointed out hereinafter.

### BRIEF DESCRIPTION OF THE DRAWINGS

FIGS. 1-11 are microphotographic images of treated corn seeds stored at 35° C. in a vacuum oven for 60 days, as described in Example 1.

### DETAILED DESCRIPTION

Generally, the methods comprise coating or contacting a solid compound with a treatment composition comprising a sublimation inhibitor as described herein.

For example, in one embodiment, the sublimation of a solid compound from the surface of a substrate is inhibited by coating or contacting the compound with a composition comprising a sublimation inhibitor. In one embodiment, the solid compound comprises a 3,5-disubstituted-1,2,4-oxadiazole useful, for example, for control of unwanted nematodes and the substrate is a seed.

Solid Compounds

In various embodiments, the compositions and methods described herein comprise a solid compound that may be prone to sublimation from the surface of a substrate under some ambient conditions. For example, as noted above, the solid compound can comprise a 3,5-disubstituted-1,2,4-oxadiazole. Such compounds are generally disclosed in U.S. Pat. Nos. 8,435,999 and 8,017,555 and U.S. Patent Application Publication Nos. 2014/0187419 A1 and 2015/0342189 A1, the contents of which are expressly incorporated herein by reference.

For example, in one embodiment, the 3,5-disubstituted-1,2,4-oxadiazole is a compound of Formula I or a salt thereof,

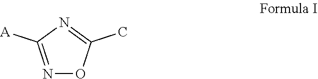

wherein A is selected from the group consisting of phenyl, pyridyl, pyrazyl, oxazolyl and isoxazolyl, each of which can be optionally independently substituted with one or more substituents selected from the group consisting of halogen, CF₃, CH₃, OCF₃, OCH₃, CN, and C(H)O; and C is selected from the group consisting of thienyl, furanyl, oxazolyl and isoxazolyl, each of which can be optionally independently substituted with one or more substituents selected from the group consisting of F, Cl, CH₃, and OCF₃.

In another embodiment, the 3,5-disubstituted-1,2,4-oxadiazole is a compound of Formula Ia or a salt thereof,

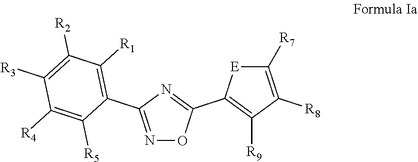

wherein R₁ and R₅ are independently selected from the group consisting of hydrogen, CH₃, F, Cl, Br, CF₃ and OCF₃; R₂ and R₄ are independently selected from the group consisting of hydrogen, F, Cl, Br, and CF₃; R₃ is selected from the group consisting of hydrogen, CH₃, CF₃, F, Cl, Br, OCF₃, OCH₃, CN, and C(H)O; R₇ and R₈ are independently selected from hydrogen and F; R₉ is selected from the group consisting of hydrogen, F, Cl, CH₃, and OCF₃; and E is 0 or S.

In another embodiment, the 3,5-disubstituted-1,2,4-oxadiazole is a compound of Formula Ib or a salt thereof,

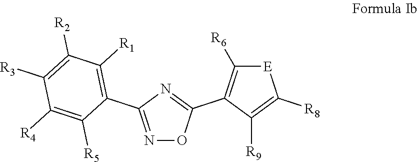

wherein R₁ and R₅ are independently selected from the group consisting of hydrogen, CH₃, F, Cl, Br, CF₃ and OCF₃; R₂ and R₄ are independently selected from the group consisting of hydrogen, F, Cl, Br, and CF₃; R₃ is selected from the group consisting of hydrogen, CH₃, CF₃, F, Cl, Br, OCF₃, OCH₃, CN, and C(H)O; R₈ is selected from hydrogen and F; R₆ and R₉ are independently selected from the group consisting of hydrogen, F, Cl, CH₃, and OCF₃; and E is O or S.

In another embodiment, the 3,5-disubstituted-1,2,4-oxadiazole is a compound of Formula II or a salt thereof,

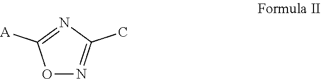

wherein A is selected from the group consisting of phenyl, pyridyl, pyrazyl, oxazolyl and isoxazolyl, each of which can be optionally independently substituted with one or more substituents selected from the group consisting of halogen, CF₃, CH₃, OCF₃, OCH₃, CN, and C(H)O; and C is selected from the group consisting of thienyl, furanyl, oxazolyl and isoxazolyl, each of which can be optionally independently substituted with one or more with substituents selected from the group consisting of F, Cl, CH₃, and OCF₃.

In another embodiment, the 3,5-disubstituted-1,2,4-oxadiazole is a compound of Formula IIa or a salt thereof,

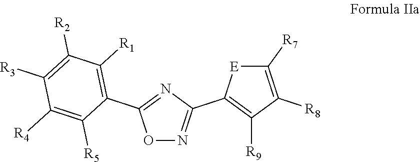

wherein R₁ and R₅ are independently selected from the group consisting of hydrogen, CH₃, F, Cl, Br, CF₃ and OCF₃; R₂ and R₄ are independently selected from the group consisting of hydrogen, F, Cl, Br, and CF₃; R₃ is selected from the group consisting of hydrogen, CH₃, CF₃, F, Cl, Br, OCF₃, OCH₃, CN, and C(H)O; R₇ and R₈ are independently selected from hydrogen and F; R₉ is selected from the group consisting of hydrogen, F, Cl, CH₃, and OCF₃; and E is O or S.

In another embodiment, the 3,5-disubstituted-1,2,4-oxadiazole is a compound of Formula IIb or a salt thereof,

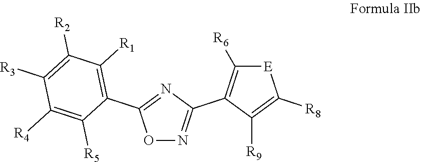

wherein R₁ and R₅ are independently selected from the group consisting of hydrogen, CH₃, F, Cl, Br, CF₃ and OCF₃; R₂ and R₄ are independently selected from the group consisting of hydrogen, F, Cl, Br, and CF₃; R₃ is selected from the group consisting of hydrogen, CH₃, CF₃, F, Cl, Br, OCF₃, OCH₃, CN, and C(H)O; R₈ is selected from hydrogen and F; R₆ and R₉ are independently selected from the group consisting of hydrogen, F, Cl, CH₃, and OCF₃; and E is O or S.

In a further embodiment, the 3,5-disubstituted-1,2,4-oxadiazole is a compound of Formula (Ia) or a salt thereof. Non-limiting examples of species include tioxazafen (i.e., 3-phenyl-5-(thiophen-2-yl)-1,2,4-oxadiazole) of Formula (Ia-i),

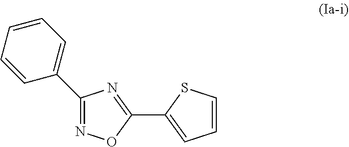 [SMILES: c1ccc(-c2noc(-c3cccs3)n2)cc1]

3-(4-chlorophenyl)-5-(furan-2-yl)-1,2,4-oxadiazole of Formula (Ia-ii),

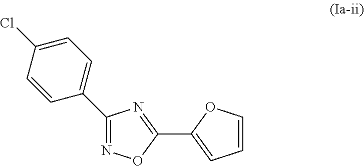 [SMILES: Clc1ccc(-c2noc(-c3ccco3)n2)cc1]

3-(4-chloro-2-methylphenyl)-5-(furan-2-yl)-1,2,4-oxadiazole of Formula (Ia-iii),

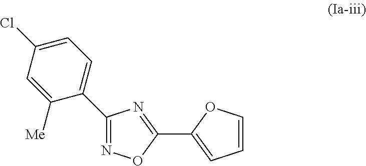 [SMILES: Cc1cc(Cl)ccc1-c1noc(-c2ccco2)n1]

and 5-(furan-2-yl)-3-phenyl-1,2,4-oxadiazole of Formula (Ia-iv).

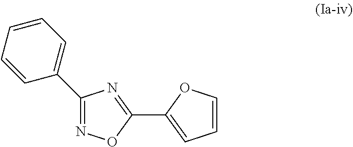 [SMILES: c1ccc(-c2noc(-c3ccco3)n2)cc1]

In another embodiment, the 3,5-disubstituted-1,2,4-oxadiazole is a compound of Formula (Ib) or a salt thereof. Non-limiting examples of species include 3-(4-bromophenyl)-5-(furan-3-yl)-1,2,4-oxadiazole of Formula (Ib-i),

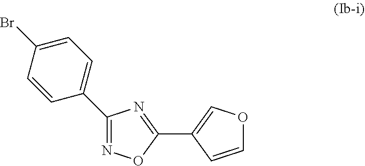 [SMILES: Brc1ccc(-c2noc(-c3ccoc3)n2)cc1]

and 3-(2,4-difluorophenyl)-5-(thiophen-3-yl)-1,2,4-oxadiazole of Formula (Ib-ii).

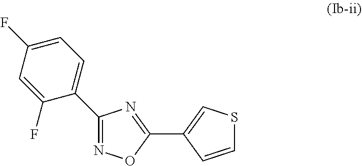 [SMILES: Fc1ccc(-c2noc(-c3ccsc3)n2)c(F)c1]

In another embodiment, the 3,5-disubstituted-1,2,4-oxadiazole is a compound of Formula (IIa) or a salt thereof. Non-limiting examples of species include 3-(thiophen-2-yl)-5-(p-tolyl)-1,2,4-oxadiazole of Formula (IIa-i),

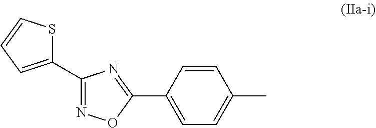 [SMILES: Cc1ccc(-c2nc(-c3cccs3)no2)cc1]

5-(3-chlorophenyl)-3-(thiophen-2-yl)-1,2,4-oxadiazole of Formula (IIa-ii),

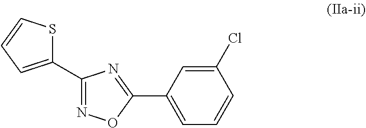 [SMILES: Clc1cccc(-c2nc(-c3cccs3)no2)c1]

and 5-(4-chloro-2-methylphenyl)-3-(furan-2-yl)-1,2,4-oxadiazole of Formula (IIa-iii).

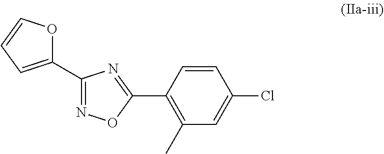 [SMILES: Cc1cc(Cl)ccc1-c1nc(-c2ccco2)no1]

Sublimation Inhibitor

Without being bound to a particular theory, it is believed that solid compounds described herein, including 3,5-disubstituted-1,2,4-oxadiazole compounds, are susceptible to sublimation, particularly when the compounds are incorporated into a seed coating applied to the surface of a substrate, such as seed. Sublimation of the 3,5-disubstituted-1,2,4-oxadiazole compound is believed to be the cause of the irregular appearance that has sometimes been observed on the surface of seeds treated with 3,5-disubstituted-1,2,4-oxadiazole compounds. Specifically, it is believed that as the 3,5-disubstituted-1,2,4-oxadiazole compound sublimates, particles that are present in the gas phase can redeposit on the surface of the seeds, and in particular can form crystals on the surface of the seeds.

The formation of crystals on the surface of the seeds results in an irregular and undesirable appearance. Crystal formation on the seed surface can also present difficulties when the seeds are planted using agricultural planting equipment, among other problems. The problem of crystal formation is particularly acute when such seeds are stored in a confined space, such as a bag, which is often used to transport and store treated seeds prior to use.

The sublimation inhibitors described herein have been found to solve this problem. When used in accordance with the methods provided herein, the sublimation inhibitors inhibit the formation of crystals from the solid composition on the surface of treated seeds.

In one theory, it is believed that the sublimation inhibitor inhibits sublimation of the 3,5-disubstituted-1,2,4-oxadiazole compound by stabilizing and/or binding with the 3,5-disubstituted-1,2,4-oxadiazole.

In other embodiments, and without being bound to a particular theory, it is believed that the sublimation inhibitor may inhibit molecules of the solid compound in the gas phase from depositing on the surface of the seed, and therefore inhibit the formation of crystals on the seed surface. More generally, a sublimation inhibitor as disclosed herein may utilize any mechanism(s) for inhibiting sublimation of compound and/or inhibiting the formation of crystals on the seed surface.

In some embodiments, the sublimation inhibitor is present in an amount sufficient to reduce the rate of sublimation of the solid compound under ambient conditions by at least about 10%, at least about 20%, at least about 30%, at least about 40%, at least about 50%, at least about 60%, at least about 70%, at least about 80%, or at least about 90% or more. For example, in one embodiment, the sublimation inhibitor reduces the rate of sublimation of a 3,5-disubstituted-1,2,4-oxadiazole in a seed treatment mixture under ambient conditions by at least about 10%, at least about 20%, at least about 30%, at least about 40%, at least about 50%, at least about 60%, at least about 70%, at least about 80%, or at least about 90% or more when the weight ratio of the sublimation inhibitor to the 3,5-disubstituted 1,2,4-oxadiazole in the mixture is as described herein.

In some embodiments, the sublimation inhibitor is present in an amount sufficient to reduce the rate of crystal formation of the solid compound on the surface of the substrate under ambient conditions by at least about 10%, at least about 20%, at least about 30%, at least about 40%, at least about 50%, at least about 60%, at least about 70%, at least about 80%, or at least about 90% or more. For example, in one embodiment, the sublimation inhibitor reduces the rate of 3,5-disubstituted-1,2,4-oxadiazole crystal formation on the surface of a seed under ambient conditions by at least about 10%, at least about 20%, at least about 30%, at least about 40%, at least about 50%, at least about 60%, at least about 70%, at least about 80%, or at least about 90% when the weight ratio of the sublimation inhibitor to the 3,5-disubstituted 1,2,4-oxadiazole in the seed treatment mixture is as described herein.

In some embodiments, the sublimation inhibitor is present in a composition containing a sublimation prone solid compound in an amount such that when the composition is cast as a film onto the surface of a substrate and dried, and the film is evaluated using a colorimeter, the percentage change in whiteness (L*) after 14 days is no greater than about 35%, no greater than about 30%, no greater than about 25%, no greater than about 20%, or no greater than about 15%. For example, in one embodiment, the solid compound is a 3,5-disubstituted-1,2,4-oxadiazole in a seed treatment mixture and the percentage change in whiteness (L*) after 14 days is no greater than about 35%, no greater than about 30%, no greater than about 25%, no greater than about 20%, or no greater than about 15% when the weight ratio of the sublimation inhibitor to the 3,5-disubstituted 1,2,4-oxadiazole in the seed treatment mixture is as described herein.

Whiteness values, L*, corresponding to the lightness value in the L*a*b* color space can be measured using a color meter known in the art (e.g. VIDEOMETER LAB3 V0101-000-11) at different times to determine the percentage change in whiteness (L*) corresponding to the degree of crystal growth.

Non-limiting examples of sublimation inhibitors include acrylic polymers, vinyl polymers, alkyl naphthalene sulfonates, sulfonate condensates lignin sulfonates and mixtures thereof. Commercially available sources of these compounds used as sublimation inhibitors may include other components in addition to the polymers identified herein.

For example, the sublimation inhibitor can comprise an acrylic polymer. The acrylic polymer can be, for example, a poly(methyl methacrylate) polymer or a copolymer derived from acrylic acid and one or more additional monomers or styrene acrylic. Non-limiting examples of acrylic polymers include olefin acrylic copolymers and styrene acrylic copolymers. Non-limiting examples of commercially available acrylic polymers include SOKALAN CP9 (an olefin/maleic acid copolymer), METASPERSE 500L (a styrene acrylate copolymer), JONCRYL 60 (a styrene acrylic copolymer), JONCRYL 62 (a styrene acrylic copolymer), JONCRYL 63 (a styrene acrylic copolymer), and TERSPERSE 2700.

In some embodiments, the sublimation inhibitor comprises a sulfonate condensate such as a naphthalene sulfonate condensate, sodium phenol sulfonate condensate, or combinations thereof. Non-limiting examples of commercially available naphthalene sulfonate condensates include AGNIQUE NSC 11NP, AGNIQUE NSC 3NP, and AGNIQUE ANS 4DNP. Non-limiting examples of commercially available sodium phenol sulfonate condensates include VULTAMOL DN.

In some embodiments, the sublimation inhibitor comprises a lignin sulfonate such as sodium lignosulfonate. Non-limiting examples of commercially available lignin sulfonates include POLYFON 0, GREENSPERSE S7, and HYACT.

In some embodiments, the sublimation inhibitor comprises a vinyl polymer. Non-limiting examples of commercially available vinyl polymers include AGRIMER AI 10LC, AGRIMER VA6W, and AGRIMER VA7W (a polyvinyl acetate polyvinyl pyrrolidone copolymer).

In some embodiments, the sublimation inhibitor comprises an anionic polymeric surfactant. A non-limiting example of a commercially available polymeric surfactant is METASPERSE 100L (a modified styrene acrylic copolymer).

In some embodiments, the sublimation inhibitor comprises an aromatic functional group in the polymer chain. Without being bound to a particular theory, it is believed that the presence of an aromatic functional group enables 7E-7E interactions with the aromatic rings in the 3,5-disubstituted 1,2,4-oxadiazole compounds, and that these interactions promote stabilization and inhibit sublimation of the 3,5-disubstituted 1,2,4-oxadiazoles.

In some embodiments, the sublimation inhibitor is chosen based on the molecular moiety of the solid compound to provide the best surface coverage over the active. In other embodiments, the sublimation inhibitor is selected based on the presence of hydrophobic or hydrophilic features that best match the functionality of the solid compound. For example, in one embodiment, a hydrophobic solid compound is matched with a hydrophobic sublimation inhibitor. In another embodiment, a hydrophilic solid compound is matched with a hydrophilic sublimation inhibitor. This creates a strong interaction between the solid compound and sublimation inhibitor. Secondary considerations that can be taken into account when selecting a sublimation inhibitor include the molecular weight, degree of functionality, and the solubility (e.g., the balance of hydrophobic/hydrophilic monomer components that allow for solubility in water but also inhibit sublimation) profile.

Methods of Preparing Treated Seeds

As discussed above, it has been discovered that the formation of 3,5-disubstituted 1,2,4-oxadiazole crystals on the surface of a treated seed can be inhibited by the presence of a sublimation inhibitor on the surface of a seed. Various methods of preparing treated seeds wherein the seed coating comprises a 3,5-disubstituted 1,2,4-oxadiazole and a sublimation inhibitor are provided below.

For example, the method of preparing a treated seed can comprise mixing a nematicidal composition comprising a 3,5-disubstituted 1,2,4-oxadiazole with a sublimation inhibitor to form a seed treatment mixture, and applying the seed treatment mixture to a seed. For example, the sublimation inhibitor may be a sublimation inhibitor that inhibits the sublimation of the 3,5-disubstituted 1,2,4-oxadiazole.

Typically, the solid compound and the sublimation inhibitor are mixed to form a seed treatment mixture shortly prior to application of the seed treatment mixture to the seed. For example, when the nematicidal composition is in the form of an aqueous suspension concentrate comprising a high concentration of the 3,5-disubstituted 1,2,4-oxadiazole, the seed treatment mixture including the sublimation inhibitor may not be storage stable (e.g., the mixture may be prone to separate into different phases). If the seed treatment mixture is prepared shortly prior to application to a seed, any storage stability issues are inconsequential.

For example, in one embodiment, when the nematicidal composition comprising a 3,5-disubstituted 1,2,4-oxadiazole is in the form of a concentrate, the concentrate is diluted with water to form a diluted nematicidal composition, which is subsequently mixed with the sublimation inhibitor to form a seed treatment mixture wherein the solid 3,5-disubstituted 1,2,4-oxadiazole is coated or contacted with the seed treatment mixture also containing the sublimation inhibitor.

In a further embodiment, the method of preparing a treated seed comprises applying a first seed treatment mixture comprising a solid (e.g., a nematicidal 3,5-disubstituted 1,2,4-oxadiazole) to a seed, and applying a second seed treatment mixture comprising the sublimation inhibitor to the seed in order that the second seed treatment mixture coats or contacts the solid on the surface of the treated seed. The order that the first and second seed treatment mixtures are applied to the surface of the seed is not critical.

Types of Seeds

The methods described herein can be used in connection with any species of plant and/or the seeds thereof. In some embodiments, however, the methods are used in connection with seeds of plant species that are agronomically important. In particular, the seeds can be of corn, peanut, canola/rapeseed, soybean, cucurbits, crucifers, cotton, beets, rice, sorghum, sugar beet, wheat, barley, rye, sunflower, tomato, sugarcane, tobacco, oats, as well as other vegetable and leaf crops. In some embodiments, the seed is corn, soybean, or cotton seed. The seed may be a transgenic seed from which a transgenic plant can grow and incorporate a transgenic event that confers, for example, tolerance to a particular herbicide or combination of herbicides, increased disease resistance, enhanced tolerance to stress and/or enhanced yield. Transgenic seeds include, but are not limited to, seeds of corn, soybean and cotton.

Methods of Applying the Seed Coating

The seed can be coated using a variety of methods known in the art. For example, the coating process can comprise spraying the seed treatment mixture onto the seed while agitating the seed in an appropriate piece of equipment such as a tumbler or a pan granulator.

In one embodiment, when coating seed on a large scale (for example a commercial scale), the seed coating may be applied using a continuous process. Typically, seed is introduced into the treatment equipment (such as a tumbler, a mixer, or a pan granulator) either by weight or by flow rate. The amount of treatment mixture that is introduced into the treatment equipment can vary depending on the seed weight to be coated, surface area of the seed, the concentration of the nematicide and/or other active ingredients in the treatment composition, the desired concentration on the finished seed, and the like. The seed treatment mixture can be applied to the seed by a variety of means, for example by a spray nozzle or revolving disc. The amount of liquid is typically determined by the assay of the formulation and the required rate of active ingredient necessary for efficacy. As the seed falls into the treatment equipment the seed can be treated (for example by misting or spraying with the seed treatment composition) and passed through the treater under continual movement/tumbling where it can be coated evenly and dried before storage or use.

In another embodiment, the seed coating may be applied using a batch process. For example, a known weight of seeds can be introduced into the treatment equipment (such as a tumbler, a mixer, or a pan granulator). A known volume of seed treatment mixture can be introduced into the treatment equipment at a rate that allows the seed treatment mixture to be applied evenly over the seeds. During the application, the seed can be mixed, for example by spinning or tumbling. The seed can optionally be dried or partially dried during the tumbling operation. After complete coating, the treated sample can be removed to an area for further drying or additional processing, use, or storage.

In an alternative embodiment, the seed coating may be applied using a semi-batch process that incorporates features from each of the batch process and continuous process embodiments set forth above.

In still another embodiment, seeds can be coated in laboratory size commercial treatment equipment such as a tumbler, a mixer, or a pan granulator by introducing a known weight of seeds in the treater, adding the desired amount of seed treatment composition, tumbling or spinning the seed and placing it on a tray to thoroughly dry.

Seed Treatment Mixtures

Also provided herein is a seed treatment mixture comprising a solid compound, for example, a 3,5-disubstituted 1,2,4-oxadiazole, and a sublimation inhibitor.

In some embodiments, the weight ratio of the sublimation inhibitor to the 3,5-disubstituted 1,2,4-oxadiazole is at least about 0.2:1, at least about 0.25:1, at least about 0.3:1, at least about 0.4:1, or at least about 0.5:1.

In some embodiments, the weight ratio of the sublimation inhibitor to the 3,5-disubstituted 1,2,4-oxadiazole is from about 0.2:1 to about 4:1, from about 0.2:1 to about 2:1, from about 0.2:1 to about 1:1, from about 0.25:1 to about 1:1, or from about 0.25:1 to about 0.75:1.

In the seed treatment mixtures described herein, the concentration of the sublimation inhibitor in the seed treatment mixture is preferably greater than 3% by weight. For example, the concentration of the sublimation inhibitor in the seed treatment mixture can be at least about 5% by weight, at least about 10% by weight, at least about 15% by weight, or at least about 20% by weight.

In the seed treatment mixtures described herein, the concentration of the 3,5-disubstituted 1,2,4-oxadiazole in the seed treatment mixture is preferably no greater than about 25% by weight, no greater than about 20% by weight, or no greater than about 15% by weight.

In one embodiment, the seed treatment mixture may be prepared, for example, by combining a nematicidal composition comprising a 3,5-disubstituted 1,2,4-oxadiazole and a sublimation inhibitor. Generally, any of the components that can be present in the nematicidal composition, as described below, may also be incorporated into the seed treatment mixtures described herein.

In some embodiments of the methods and mixtures described herein, the nematicidal composition used in preparation of the seed treatment mixture comprises a 3,5-disubstituted 1,2,4-oxadiazole.

In other embodiments, the nematicidal composition is an aqueous suspension concentrate composition. Aqueous suspension concentrate compositions comprising 3,5-disubstituted 1,2,4-oxadiazoles are generally disclosed in U.S. Patent Application Publication Nos. 2014/0187419 A1 and 2015/0342189 A1, each of which is expressly incorporated herein by reference. The 3,5-disubstituted 1,2,4-oxadiazole is present as a dispersed solid phase in the aqueous suspension concentrate composition and the concentrate is diluted with water to form a diluted nematicidal composition, to which the sublimation inhibitor can be added to form a seed treatment mixture as described above.

The nematicidal composition in some embodiments comprises at least about 10%, at least about 15%, at least about 20%, at least about 25%, at least about 30%, at least about 35%, at least about 40%, at least about 45%, or at least about 50% by weight of the 3,5-disubstituted 1,2,4-oxadiazole. In one embodiment, the nematicidal composition comprises at least about 40% by weight of the 3,5-disubstituted 1,2,4-oxadiazole. In some embodiments, the nematicidal composition comprises at least about 45% by weight of the 3,5-disubstituted 1,2,4-oxadiazole, or even higher (e.g., at least about 50% by weight).

The nematicidal composition can comprise the 3,5-disubstituted 1,2,4-oxadiazole in a concentration of at least about 100 g/L, at least about 200 g/L, at least about 250 g/L, at least about 300 g/L, at least about 350 g/L, at least about 400 g/L, at least about 450 g/L, at least about 500 g/L, at least about 550 g/L, at least about 600 g/L, at least about 650 g/L, or at least about 700 g/L. The concentration of the 3,5-disubstituted 1,2,4-oxadiazole can range from about 400 g/L to about 700 g/L, from about 450 g/L to about 750 g/L, or from about 450 g/L to about 700 g/L.

Additional Active Ingredients

In some embodiments, the seed treatment mixture comprises one or more additional active ingredients in combination with the solid compound described herein. The additional active ingredient may be present in the composition. Alternatively, it may be incorporated into the seed treatment mixture shortly prior to application of the mixture to a seed.

For example, in addition to the solid compounds (e.g., 3,5-disubstituted-1,2,4-oxadiazoles) described herein, compositions and formulations in some embodiments may further comprise one or more pesticidal agents. Pesticidal agents include chemical pesticides and biopesticides or biocontrol agents. Various types of chemical pesticides and biopesticides include acaricides, insecticides, nematicides, fungicides, gastropodicides, herbicides, virucides, bactericides, and combinations thereof. Biopesticides or biocontrol agents may include bacteria, fungi, beneficial nematodes, and viruses that exhibit pesticidal activity. The compositions described herein may comprise other agents for pest control, such as microbial extracts, plant growth activators, and/or plant defense agents.

Compositions in some embodiments may comprise one or more chemical acaricides, insecticides, and/or nematicides. Non-limiting examples of chemical acaricides, insecticides, and/or nematicides may include one or more carbamates, diamides, macrocyclic lactones, neonicotinoids, organophosphates, phenylpyrazoles, pyrethrins, spinosyns, synthetic pyrethroids, tetronic acids and/or tetramic acids. Non-limiting examples of chemical acaricides, insecticides and nematicides that can be useful in compositions of the present disclosure include abamectin, acrinathrin, aldicarb, aldoxycarb, alpha-cypermethrin, betacyfluthrin, bifenthrin, cyhalothrin, cypermethrin, deltamethrin, csfenvalcrate, etofenprox, fenpropathrin, fenvalerate, flucythrinate, fosthiazate, lambda-cyhalothrin, gamma-cyhalothrin, permethrin, tau-fluvalinate, transfluthrin, zeta-cypermethrin, cyfluthrin, bifenthrin, tefluthrin, eflusilanat, fubfenprox, pyrethrin, resmethrin, imidacloprid, acetamiprid, thiamethoxam, nitenpyram, thiacloprid, dinotefuran, clothianidin, imidaclothiz, chlorfluazuron, diflubenzuron, lufenuron, teflubenzuron, triflumuron, novaluron, flufenoxuron, hexaflumuron, bistrifluoron, noviflumuron, buprofezin, cyromazine, methoxyfenozide, tebufenozide, halofenozide, chromafenozide, endosulfan, fipronil, ethiprole, pyrafluprole, pyriprole, flubendiamide, chlorantraniliprole (e.g., Rynaxypyr), cyazypyr, emamectin, emamectin benzoate, abamectin, ivermectin, milbemectin, lepimectin, tebufenpyrad, fenpyroximate, pyridaben, fenazaquin, pyrimidifen, tolfenpyrad, dicofol, cyenopyrafen, cyflumetofen, acequinocyl, fluacrypyrin, bifenazate, diafenthiuron, etoxazole, clofentezine, spinosad, triarathen, tetradifon, propargite, hexythiazox, bromopropylate, chinomethionat, amitraz, pyrifluquinazon, pymetrozine, flonicamid, pyriproxyfen, diofenolan, chlorfenapyr, metaflumizone, indoxacarb, chlorpyrifos, spirodiclofen, spiromesifen, spirotetramat, pyridalyl, spinctoram, acephate, triazophos, profenofos, oxamyl, spinetoram, fenamiphos, fenamipclothiahos, 4-{[(6-chloropyrid-3-yl)methyl](2,2-difluoroethyl)amino}furan-2(5H)-one, 3,5-disubstituted-1,2,4-oxadiazole compounds, 3-phenyl-5-(thien-2-yl)-1,2,4-oxadiazole, cadusaphos, carbaryl, carbofuran, ethoprophos, thiodicarb, aldicarb, aldoxycarb, metamidophos, methiocarb, sulfoxaflor, cyantraniliprole and tioxazofen and combinations thereof. Additional non-limiting examples of chemical acaricides, insecticides, and/or nematicides may include one or more of abamectin, aldicarb, aldoxycarb, bifenthrin, carbofuran, chlorantraniliporle, chlothianidin, cyfluthrin, cyhalothrin, cypermethrin, cyantraniliprole, deltamethrin, dinotefuran, emamectin, ethiprole, fenamiphos, fipronil, flubendiamide, fosthiazate, imidacloprid, ivermectin, lambda-cyhalothrin, milbemectin, nitenpyram, oxamyl, permethrin, spinetoram, spinosad, spirodichlofen, spirotetramat, tefluthrin, thiacloprid, thiamethoxam and/or thiodicarb, and combinations thereof.

Additional non-limiting examples of acaricides, insecticides and nematicides that may be included or used in compositions in some embodiments may be found in Steffey and Gray, Managing Insect Pests, Illinois Agronomy Handbook (2008); and Niblack, Nematodes, Illinois Agronomy Handbook (2008), the contents and disclosures of which are incorporated herein by reference. Non-limiting examples of commercial insecticides which may be suitable for the compositions disclosed herein include CRUISER (Syngenta, Wilmington, Delware), GAUCHO and PONCHO (Gustafson, Plano, Tex.). Active ingredients in these and other commercial insecticides may include thiamethoxam, clothianidin, and imidacloprid. Commercial acaricides, insecticides, and/or nematicides may be used in accordance with a manufacturer's recommended amounts or concentrations.

According to some embodiments, compositions in some embodiments may comprise one or more biopesticidal microorganisms, the presence and/or output of which is toxic to an acarid, insect and/or nematode. For example, the compositions described herein may comprise one or more of Bacillus firmus 1-1582, Bacillus mycoides AQ726, NRRL B-21664; Beauveria bassiana ATCC-74040, Beauveria bassiana ATCC-74250, Burkholderia sp. A396 sp. nov. rinojensis, NRRL B-50319, Chromobacterium subtsugae NRRL B-30655, Chromobacterium vaccinii NRRL B-50880, Flavobacterium H492, NRRL B-50584, Metarhizium anisopliae F52 (also known as Metarhizium anisopliae strain 52, Metarhizium anisopliae strain 7, Metarhizium anisopliae strain 43, and/or Metarhizium anisopliae BIO-1020, TAE-001; deposited as DSM 3884, DSM 3885, ATCC 90448, SD 170 and ARSEF 7711), Paecilomyces fumosoroseus FE991, and combinations thereof.

Compositions in some embodiments comprise one or more chemical fungicides. Non-limiting examples of chemical fungicides may include one or more aromatic hydrocarbons, benzthiadiazole, carboxylic acid amides, morpholines, phenylamides, phosphonates, thiazolidines, thiophene, quinone outside inhibitors and strobilurins, such as azoxystrobin, coumethoxystrobin, coumoxystrobin, dimoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, 2-[2-(2,5-dimethyl-phenoxymethyl)-phenyl]-3-methoxy-acrylic acid methyl ester, and 2-(2-(3-(2,6-dichlorophenyl)-1-methyl-allylideneaminooxymethyl)-phenyl)-2-methoxyimino-N-methyl-acetamide, carboxamides, such as carboxanilides (e.g., benalaxyl, benalaxyl-M, benodanil, bixafen, boscalid, carboxin, fenfuram, fenhexamid, flutolanil, fluxapyroxad, furametpyr, isopyrazam, isotianil, kiralaxyl, mepronil, metalaxyl, metalaxyl-M (mefenoxam), ofurace, oxadixyl, oxycarboxin, penflufen, penthiopyrad, sedaxane, tecloftalam, thifluzamide, tiadinil, 2-amino-4-methyl-thiazole-5-carboxanilide, N-(4′-trifluoromethylthiobiphenyl-2-yl)-3-difluoromethyl-1-methyl-1H-pyrazole-4-carboxamide, N-(2-(1,3,3-trimethylbutyl)-phenyl)-1,3-dimethyl-5-fluoro-1H-pyrazole-4-carboxamide), carboxylic morpholides (e.g., dimethomorph, flumorph, pyrimorph), benzoic acid amides (e.g., flumetover, fluopicolide, fluopyram, zoxamide), carpropamid, dicyclomet, mandiproamid, oxytetracyclin, silthiofam, and N-(6-methoxy-pyridin-3-yl) cyclopropanecarboxylic acid amide, azoles, such as triazoles (e.g., azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole) and imidazoles (e.g., cyazofamid, imazalil, pefurazoate, prochloraz, triflumizol); heterocyclic compounds, such as pyridines (e.g., fluazinam, pyrifenox (cf D1b), 3-[5-(4-chloro-phenyl)-2,3-dimethyl-isoxazolidin-3-yl]-pyridine, 3-[5-(4-methyl-phenyl)-2,3-dimethyl-isoxazolidin-3-yl]-pyridine), pyrimidines (e.g., bupirimate, cyprodinil, diflumetorim, fenarimol, ferimzone, mepanipyrim, nitrapyrin, nuarimol, pyrimethanil), piperazines (e.g., triforine), pirroles (e.g., fenpiclonil, fludioxonil), morpholines (e.g., aldimorph, dodemorph, dodemorph-acetate, fenpropimorph, tridemorph), piperidines (e.g., fenpropidin); dicarboximides (e.g., fluoroimid, iprodione, procymidone, vinclozolin), non-aromatic 5-membered heterocycles (e.g., famoxadone, fenamidone, flutianil, octhilinone, probenazole, 5-amino-2-isopropyl-3-oxo-4-ortho-tolyl-2,3-dihydro-pyrazole-1-carbothioic acid S-allyl ester), acibenzolar-S-methyl, ametoctradin, amisulbrom, anilazin, blasticidin-S, captafol, captan, chinomethionat, dazomet, debacarb, diclomezine, difenzoquat, difenzoquat-methylsulfate, fenoxanil, Folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxy-pyrimidin-2-yl)-2-methyl-1H-benzoimidazole and 5-chloro-7-(4-methylpiperidin-1-yl)-6-(2,4,6-trifluorophenyl)-[1,2,4]triazolo-[1,5-a]pyrimidine; benzimidazoles, such as carbendazim; and other active substances, such as guanidines (e.g., guanidine, dodine, dodine free base, guazatine, guazatine-acetate, iminoctadine), iminoctadine-triacetate and iminoctadine-tris(albesilate); antibiotics (e.g., kasugamycin, kasugamycin hydrochloride-hydrate, streptomycin, polyoxine and validamycin A), nitrophenyl derivates (e.g., binapacryl, dicloran, dinobuton, dinocap, nitrothal-isopropyl, tecnazen). organometal compounds (e.g., fentin salts, such as fentin-acetate, fentin chloride, fentin hydroxide); sulfur-containing heterocyclyl compounds (e.g., dithianon, isoprothiolane), organophosphorus compounds (e.g., edifenphos, fosetyl, fosetyl-aluminum, iprobenfos, phosphorus acid and its salts, pyrazophos, tolclofos-methyl), organochlorine compounds (e.g., chlorothalonil, dichlofluanid, dichlorophen, flusulfamide, hexachlorobenzene, pencycuron, pentachlorphenole and its salts, phthalide, quintozene, thiophanate-methyl, thiophanates, tolylfluanid, N-(4-chloro-2-nitro-phenyl)-N-ethyl-4-methyl-benzenesulfonamide) and inorganic active substances (e.g., Bordeaux mixture, copper acetate, copper hydroxide, copper oxychloride, basic copper sulfate, sulfur) and combinations thereof. In an aspect, compositions in some embodiments comprise acibenzolar-S-methyl, azoxystrobin, benalaxyl, bixafen, boscalid, carbendazim, cyproconazole, dimethomorph, epoxiconazole, fludioxonil, fluopyram, fluoxastrobin, flutianil, flutolanil, fluxapyroxad, fosetyl-A1, ipconazole, isopyrazam, kresoxim-methyl, mefenoxam, metalaxyl, metconazole, myclobutanil, orysastrobin, penflufen, penthiopyrad, picoxystrobin, propiconazole, prothioconazole, pyraclostrobin, sedaxane, silthiofam, tebuconazole, thiabendazole, thifluzamide, thiophanate, tolclofos-methyl, trifloxystrobin and triticonazole, and combinations thereof.

For additional examples of fungicides that may be included in compositions in some embodiments see, e.g., Bradley, Managing Diseases, Illinois Agronomy Handbook (2008), the content and disclosure of which are incorporated herein by reference.

Fungicides useful for compositions in some embodiments may exhibit activity against one or more fungal plant pathogens, including but not limited to Phytophthora, Rhizoctonia, Fusarium, Pythium, Phomopsis, Selerotinia or Phakopsora, and combinations thereof. Non-limiting examples of commercial fungicides which may be suitable for the compositions in some embodiments include PROTÉGÉ, RIVAL or ALLEGIANCE FL or LS (Gustafson, Plano, Tex.), WARDEN RTA (Agrilance, St. Paul, Minn.), APRON XL, APRON MAXX RTA or RFC, MAXIM 4FS or XL (Syngenta, Wilmington, Del.), CAPTAN (Arvesta, Guelph, Ontario) and PROTREAT (Nitragin Argentina, Buenos Ares, Argentina). Active ingredients in these and other commercial fungicides include, but are not limited to, fludioxonil, mefenoxam, azoxystrobin and metalaxyl. Commercial fungicides may be used in accordance with a manufacturer's recommended amounts or concentrations.

According to some embodiments, compositions in some embodiments may comprise one or more biopesticidal microorganisms, the presence and/or output of which is toxic to at least one fungus, bacteria, or both. For example, compositions of in some embodiments may comprise one or more of Ampelomyces quisqualis AQ 10® (Intrachem Bio GmbH & Co. KG, Germany), Aspergillus flavus AFLA-GUARD® (Syngenta Crop Protection, Inc., CH), Aureobasidium pullulans BOTECTOR® (bio-ferm GmbH, Germany), Bacillus pumilus AQ717 (NRRL B-21662), Bacillus pumilus NRRL B-30087, Bacillus AQ175 (ATCC 55608), Bacillus AQ177 (ATCC 55609), Bacillus subtilis AQ713 (NRRL B-21661), Bacillus subtilis AQ743 (NRRL B-21665), Bacillus amyloliquefaciens FZB24, Bacillus amyloliquefaciens FZB42, Bacillus amyloliquefaciens NRRL B-50349, Bacillus amyloliquefaciens TJ1000 (also known as 1BE, isolate ATCC BAA-390), Bacillus subtilis ATCC 55078, Bacillus subtilis ATCC 55079, Bacillus thuringiensis AQ52 (NRRL B-21619), Candida oleophila 1-182 (e.g., ASPIRE® from Ecogen Inc., USA), Candida saitoana BIOCURE® (in mixture with lysozyme; BASF, USA) and BIOCOAT® (ArystaLife Science, Ltd., Cary, N.C.), Clonostachys rosea f. catenulata (also referred to as Gliocladium catenulatum) J1446 (PRESTOP®, Verdera, Finland), Coniothyrium minitans CONTANS® (Prophyta, Germany), Cryphonectria parasitica (CNICM, France), Cryptococcus albidus YIELD PLUS® (Anchor Bio-Technologies, South Africa), Fusarium oxysporum BIOFOX® (from S.I.A.P.A., Italy) and FUSACLEAN® (Natural Plant Protection, France), Metschnikowia fructicola SHEMER® (Agrogreen, Israel), Microdochium dimerum ANTIBOT® (Agrauxine, France), Muscodor albus NRRL 30547, Muscodor roseus NRRL 30548, Phlebiopsis gigantea ROTSOP® (Verdera, Finland), Pseudozyma flocculosa SPORODEX® (Plant Products Co. Ltd., Canada), Pythium oligandrum DV74 (POLYVERSUM®, Remeslo SSRO, Biopreparaty, Czech Rep.), Reynoutria sachlinensis (e.g., REGALIA® from Marrone Biolnnovations, USA), Streptomyces NRRL B-30145, Streptomyces M1064, Streptomyces galbus NRRL 30232, Streptomyces lydicus WYEC 108 (ATCC 55445), Streptomyces violaceusniger YCED 9 (ATCC 55660; DE-THATCH-9®, DECOMP-9® and THATCH CONTROL®, Idaho Research Foundation, USA), Streptomyces WYE 53 (ATCC 55750; DE-THATCH-9®, DECOMP-9® and THATCH CONTROL®, Idaho Research Foundation, USA), Talaromyces flavus V117b (PROTUS®, Prophyta, Germany), Trichoderma asperellum SKT-1 (ECO-HOPE®, Kumiai Chemical Industry Co., Ltd., Japan), Trichoderma atroviride LC52 (SENTINEL®, Agrimm Technologies Ltd, NZ), Trichoderma harzianum T-22 (PLANTSHIELD®, der Firma BioWorks Inc., USA), Trichoderma harzianum TH-35 (ROOT PRO®, from Mycontrol Ltd., Israel), Trichoderma harzianum T-39 (TRICHODEX®, Mycontrol Ltd., Israel; TRICHODERMA 2000®, Makhteshim Ltd., Israel), Trichoderma harzianum ICC012 and Trichoderma viride TRICHOPEL (Agrimm Technologies Ltd, NZ), Trichoderma harzianum ICC012 and Trichoderma viride ICC080 (REMEDIER® WP, Isagro Ricerca, Italy), Trichoderma polysporum and Trichoderma harzianum (BINAB®, BINAB Bio-Innovation AB, Sweden), Trichoderma stromaticum TRICOVAB® (C.E.P.L.A.C., Brazil), Trichoderma virens GL-21 (SOILGARD®, Certis LLC, USA), Trichoderma virens G1-3 (ATCC 57678), Trichoderma virens G1-21 (Thermo Trilogy Corporation, Wasco, Calif.), Trichoderma virens G1-3 and Bacillus amyloliquefaciens FZB24, Trichoderma virens G1-3 and Bacillus amyloliquefaciens NRRL B-50349, Trichoderma virens G1-3 and Bacillus amyloliquefaciens TJ1000, Trichoderma virens G1-21 and Bacillus amyloliquefaciens FZB24, Trichoderma virens G1-21 and Bacillus amyloliquefaciens NRRL B-50349, Trichoderma virens G1-21 and Bacillus amyloliquefaciens TJ1000, Trichoderma viride TRIECO® (Ecosense Labs. (India) Pvt. Ltd., India, BIO-CURE® F from T. Stanes & Co. Ltd., Indien), Trichoderma viride TV1 (Agribiotec srl, Italy), Trichoderma viride ICC080, and/or Ulocladium oudemansii HRU3 (BOTRY-ZEN®, Botry-Zen Ltd, NZ), and combinations thereof.

Compositions in some embodiments may comprise one or more chemical herbicides. The herbicides may be a pre-emergent herbicide, a post-emergent herbicide, or a combination thereof. Non-limiting examples of chemical herbicides may comprise one or more acetyl CoA carboxylase (ACCase) inhibitors, acetolactate synthase (ALS) inhibitors, acetanilides, acetohydroxy acid synthase (AHAS) inhibitors, photosystem II inhibitors, photosystem I inhibitors, protoporphyrinogen oxidase (PPO or Protox) inhibitors, carotenoid biosynthesis inhibitors, enolpyruvylshikimate-3-phosphate (EPSP) synthase inhibitors, glutamine synthetase inhibitors, dihydropteroate synthetase inhibitors, mitosis inhibitors, 4-hydroxyphenyl-pyruvate-dioxygenase (4-HPPD) inhibitors, synthetic auxins, auxin herbicide salts, auxin transport inhibitors, nucleic acid inhibitors and/or one or more salts, esters, racemic mixtures and/or resolved isomers thereof. Non-limiting examples of chemical herbicides that can be useful in compositions of the present disclosure include 2,4-dichlorophenoxyacetic acid (2,4-D), 2,4,5-trichlorophenoxyacetic acid (2,4,5-T), ametryn, amicarbazone, aminocyclopyrachlor, acetochlor, acifluorfen, alachlor, atrazine, azafenidin, bentazon, benzofenap, bifenox, bromacil, bromoxynil, butachlor, butafenacil, butroxydim, carfentrazone-ethyl, chlorimuron, chlorotoluro, clethodim, clodinafop, clomazone, cyanazine, cycloxydim, cyhalofop, desmedipham, desmetryn, dicamba, diclofop, dimefuron, diuron, dithiopyr, fenoxaprop, fluazifop, fluazifop-P, fluometuron, flufenpyr-ethyl, flumiclorac, flumiclorac-pentyl, flumioxazin, fluoroglycofen, fluthiacet-methyl, fomesafen, fomesafen, glyphosate, glufosinate, halosulfuron, haloxyfop, hexazinone, imazamox, imazaquin, imazethapyr, ioxynil, isoproturon, isoxaflutole, lactofen, linuron, mecoprop, mecoprop-P, mesotrion, metamitron, metazochlor, methibenzuron, metolachlor (and S-metolachlor), metoxuron, metribuzin, monolinuron, oxadiargyl, oxadiazon, oxyfluorfen, phenmedipham, pretilachlor, profoxydim, prometon, prometry, propachlor, propanil, propaquizafop, propisochlor, pyraflufen-ethyl, pyrazon, pyrazolynate, pyrazoxyfen, pyridate, quizalofop, quizalofop-P (e.g., quizalofop-ethyl, quizalofop-P-ethyl, clodinafop-propargyl, cyhalofop-butyl, diclofop-methyl, fenoxaprop-P-ethyl, fluazifop-P-butyl, haloxyfop-methyl, haloxyfop-R-methyl), saflufenacil, sethoxydim, siduron, simazine, simetryn, sulcotrione, sulfentrazone, tebuthiuron, tembotrione, tepraloxydim, terbacil, terbumeton, terbuthylazine, thaxtomin (e.g., the thaxtomins described in U.S. Pat. No. 7,989,393), thenylchlor, tralkoxydim, triclopyr, trietazine, trifloxysulfuron, tropramezone, salts and esters thereof; racemic mixtures and resolved isomers thereof and combinations thereof. In an embodiment, compositions comprise acetochlor, clethodim, dicamba, flumioxazin, fomesafen, glyphosate, glufosinate, mesotrione, quizalofop, saflufenacil, sulcotrione, S-3100 and/or 2,4-D, and combinations thereof.

Additional examples of herbicides that may be included in compositions in some embodiments may be found in Hager, Weed Management, Illinois Agronomy Handbook (2008); and Loux et al., Weed Control Guide for Ohio, Indiana and Illinois (2015), the contents and disclosures of which are incorporated herein by reference. Commercial herbicides may be used in accordance with a manufacturer's recommended amounts or concentrations.

Compositions in some embodiments may comprise one or more virucides.

According to some embodiments, compositions in some embodiments may comprise one or more biopesticidal or herbicidal microorganisms, the presence and/or output of which is toxic to at least one insect, plant (weed), or phytopathogenic virus, as the case may be.

Additional examples of biopesticides that may be included or used in compositions in some embodiments may be found in Burges, supra; Hall & Menn, Biopesticides: Use and Delivery (Humana Press) (1998); McCoy et al., Entomogenous fungi, in CRC Handbook of Natural Pesticides. Microbial Pesticides, Part A. Entomogenous Protozoa and Fungi (C. M. Inoffo, ed.), Vol. 5:151-236 (1988); Samson et al., Atlas of Entomopathogenic Fungi (Springer-Verlag, Berlin) (1988); and deFaria and Wraight, Mycoinsecticides and Mycoacaricides: A comprehensive list with worldwide coverage and international classification of formulation types, Biol. Control (2007), the contents and disclosures of which are incorporated herein by reference. In certain embodiments, a biocontrol microbe may comprise a bacterium of the genus Actinomycetes, Agrobacterium, Arthrobacter, Alcaligenes, Aureobacterium, Azobacter, Bacillus, Beijerinckia, Brevibacillus, Burkholderia, Chromobacterium, Clostridium, Clavibacter, Comamonas, Corynebacterium, Curtobacterium, Enterobacter, Flavobacterium, Gluconobacter, Hydrogenophaga, Klebsiella, Methylobacterium, Paenibacillus, Pasteuria, Photorhabdus, Phyllobacterium, Pseudomonas, Rhizobium, Serratia, Sphingobacterium, Stenotrophomonas, Variovorax, and Xenorhabdus, or any combination thereof. According to some embodiments, a biopesticidal microbe may include one or more of Bacillus amyloliquefaciens, Bacillus cereus, Bacillus firmus, Bacillus, lichenformis, Bacillus pumilus, Bacillus sphaericus, Bacillus subtilis, Bacillus thuringiensis, Chromobacterium suttsuga, Pasteuria penetrans, Pasteuria usage, and Pseudomona fluorescens. According to some embodiments, a biopesticidal microbe may comprise a fungus of the genus Alternaria, Ampelomyces, Aspergillus, Aureobasidium, Beauveria, Colletotrichum, Coniothyrium, Gliocladium, Metarhizium, Muscodor, Paecilomyces, Trichoderma, Typhula, Ulocladium, and Verticillium. In another aspect a fungus is Beauveria bassiana, Coniothyrium minitans, Gliocladium vixens, Muscodor albus, Paecilomyces lilacinus, or Trichoderma polysporum.

A composition in some embodiments may comprise one or more biocidal agents. A biocidal component may be included or used to prevent fungal and/or bacterial growth in the composition, particularly when the composition is placed in storage. Examples of biocidal agents include dichlorophen or benzyl alcohol hemiformal based compounds, benzoisothiazolinones and rhamnolipids. Non-limiting examples of commercially available biocidal agents include ACTICIDE (THOR), PROXEL (Arch Chemical), and ZONIX (Jeneil).

In addition to a microbial strain or isolate compositions and formulations in some embodiments may further comprise one or more agriculturally beneficial agents, such as biostimulants, nutrients, plant signal molecules, or biologically active agents.

According to some embodiments, compositions may comprise one or more beneficial biostimulants. Biostimulants may enhance metabolic or physiological processes such as respiration, photosynthesis, nucleic acid uptake, ion uptake, nutrient delivery, or a combination thereof. Non-limiting examples of biostimulants that may be included or used in the compositions described herein may include seaweed extracts (e.g., ascophyllum nodosum), bacterial extracts (e.g., extracts of one or more diazotrophs, phosphate-solubilizing microorganisms and/or biopesticides), fungal extracts, humic acids (e.g., potassium humate), fulvic acids, myo-inositol, and/or glycine, and any combinations thereof. According to some embodiments, the biostimulants may comprise one or more Azospirillum extracts (e.g., an extract of media comprising A. brasilense INTA Az-39), one or more Bradyrhizobium extracts (e.g., an extract of media comprising B. elkanii SEMIA 501, B. elkanii SEMIA 587, B. elkanii SEMIA 5019, B. japonicum NRRL B-50586 (also deposited as NRRL B-59565), B. japonicum NRRL B-50587 (also deposited as NRRL B-59566), B. japonicum NRRL B-50588 (also deposited as NRRL B-59567), B. japonicum NRRL B-50589 (also deposited as NRRL B-59568), B. japonicum NRRL B-50590 (also deposited as NRRL B-59569), B. japonicum NRRL B-50591 (also deposited as NRRL B-59570), B. japonicum NRRL B-50592 (also deposited as NRRL B-59571), B. japonicum NRRL B-50593 (also deposited as NRRL B-59572), B. japonicum NRRL B-50594 (also deposited as NRRL B-50493), B. japonicum NRRL B-50608, B. japonicum NRRL B-50609, B. japonicum NRRL B-50610, B. japonicum NRRL B-50611, B. japonicum NRRL B-50612, B. japonicum NRRL B-50726, B. japonicum NRRL B-50727, B. japonicum NRRL B-50728, B. japonicum NRRL B-50729, B. japonicum NRRL B-50730, B. japonicum SEMIA 566, B. japonicum SEMIA 5079, B. japonicum SEMIA 5080, B. japonicum USDA 6, B. japonicum USDA 110, B. japonicum USDA 122, B. japonicum USDA 123, B. japonicum USDA 127, B. japonicum USDA 129 and/or B. japonicum USDA 532C), one or more Rhizobium extracts (e.g., an extract of media comprising R. leguminosarum S012A-2), one or more Sinorhizobium extracts (e.g., an extract of media comprising S. fredii CCBAU114 and/or S. fredii USDA 205), one or more Penicillium extracts (e.g., an extract of media comprising P. bilaiae ATCC 18309, P. bilaiae ATCC 20851, P. bilaiae ATCC 22348, P. bilaiae NRRL 50162, P. bilaiae NRRL 50169, P. bilaiae NRRL 50776, P. bilaiae NRRL 50777, P. bilaiae NRRL 50778, P. bilaiae NRRL 50777, P. bilaiae NRRL 50778, P. bilaiae NRRL 50779, P. bilaiae NRRL 50780, P. bilaiae NRRL 50781, P. bilaiae NRRL 50782, P. bilaiae NRRL 50783, P. bilaiae NRRL 50784, P. bilaiae NRRL 50785, P. bilaiae NRRL 50786, P. bilaiae NRRL 50787, P. bilaiae NRRL 50788, P. bilaiae RS7B-SD1, P. brevicompactum AgRF18, P. canescens ATCC 10419, P. expansum ATCC 24692, P. expansum YT02, P. fellatanum ATCC 48694, P. gaestrivorus NRRL 50170, P. glabrum DAOM 239074, P. glabrum CBS 229.28, P. janthinellum ATCC 10455, P. lanosocoeruleum ATCC 48919, P. radicum ATCC 201836, P. radicum FRR 4717, P. radicum FRR 4719, P. radicum N93/47267 and/or P. raistrickii ATCC 10490), one or more Pseudomonas extracts (e.g., an extract of media comprising P. jessenii PS06), one or more acaricidal, insecticidal and/or nematicidal extracts (e.g., an extract of media comprising Bacillus firmus 1-1582, Bacillus mycoides AQ726, NRRL B-21664; Beauveria bassiana ATCC-74040, Beauveria bassiana ATCC-74250, Burkholderia sp. A396 sp. nov. rinojensis, NRRL B-50319, Chromobacterium subtsugae NRRL B-30655, Chromobacterium vaccinii NRRL B-50880, Flavobacterium H492, NRRL B-50584, Metarhizium anisopliae F52 (also known as Metarhizium anisopliae strain 52, Metarhizium anisopliae strain 7, Metarhizium anisopliae strain 43 and Metarhizium anisopliae BIO-1020, TAE-001; deposited as DSM 3884, DSM 3885, ATCC 90448, SD 170 and ARSEF 7711) and/or Paecilomyces fumosoroseus FE991), and/or one or more fungicidal extracts (e.g., an extract of media comprising Ampelomyces quisqualis AQ 10® (Intrachem Bio GmbH & Co. KG, Germany), Aspergillus flavus AFLA-GUARD® (Syngenta Crop Protection, Inc., CH), Aureobasidium pullulans BOTECTOR® (bio-ferm GmbH, Germany), Bacillus pumilus AQ717 (NRRL B-21662), Bacillus pumilus NRRL B-30087, Bacillus AQ175 (ATCC 55608), Bacillus AQ177 (ATCC 55609), Bacillus subtilis AQ713 (NRRL B-21661), Bacillus subtilis AQ743 (NRRL B-21665), Bacillus amyloliquefaciens FZB24, Bacillus amyloliquefaciens NRRL B-50349, Bacillus amyloliquefaciens TJ1000 (also known as 1BE, isolate ATCC BAA-390), Bacillus thuringiensis AQ52 (NRRL B-21619), Candida oleophila 1-82 (e.g., ASPIRE® from Ecogen Inc., USA), Candida saitoana BIOCURE® (in mixture with lysozyme; BASF, USA) and BIOCOAT® (ArystaLife Science, Ltd., Cary, N.C.), Clonostachys rosea f catenulata (also referred to as Gliocladium catenulatum) J1446 (PRESTOP®, Verdera, Finland), Coniothyrium minitans CONTANS® (Prophyta, Germany), Cryphonectria parasitica (CNICM, France), Cryptococcus albidus YIELD PLUS® (Anchor Bio-Technologies, South Africa), Fusarium oxysporum BIOFOX® (from S.I.A.P.A., Italy) and FUSACLEAN® (Natural Plant Protection, France), Metschnikowia fructicola SHEMER® (Agrogreen, Israel), Microdochium dimerum ANTIBOT® (Agrauxine, France), Muscodor albus NRRL 30547, Muscodor roseus NRRL 30548, Phlebiopsis gigantea ROTSOP® (Verdera, Finland), Pseudozyma flocculosa SPORODEX® (Plant Products Co. Ltd., Canada), Pythium oligandrum DV74 (POLYVERSUM®, Remeslo SSRO, Biopreparaty, Czech Rep.), Reynoutria sachlinensis (e.g., REGALIA® from Marrone BioInnovations, USA), Streptomyces NRRL B-30145, Streptomyces M1064, Streptomyces galbus NRRL 30232, Streptomyces lydicus WYEC 108 (ATCC 55445), Streptomyces violaceusniger YCED 9 (ATCC 55660; DE-THATCH-9®, DECOMP-9® and THATCH CONTROL®, Idaho Research Foundation, USA), Streptomyces WYE 53 (ATCC 55750; DE-THATCH-9®, DECOMP-9® and THATCH CONTROL®, Idaho Research Foundation, USA), Talaromyces flavus V117b (PROTUS®, Prophyta, Germany), Trichoderma asperellum SKT-1 (ECO-HOPE®, Kumiai Chemical Industry Co., Ltd., Japan), Trichoderma atroviride LC52 (SENTINEL®, Agrimm Technologies Ltd, NZ), Trichoderma harzianum T-22 (PLANTSHIELD®, der Firma BioWorks Inc., USA), Trichoderma harzianum TH-35 (ROOT PRO®, from Mycontrol Ltd., Israel), Trichoderma harzianum T-39 (TRICHODEX®, Mycontrol Ltd., Israel; TRICHODERMA 2000®, Makhteshim Ltd., Israel), Trichoderma harzianum ICC012 and Trichoderma viride TRICHOPEL (Agrimm Technologies Ltd, NZ), Trichoderma harzianum ICC012 and Trichoderma viride ICC080 (REMEDIER® WP, Isagro Ricerca, Italy), Trichoderma polysporum and Trichoderma harzianum (BINAB®, BINAB Bio-Innovation AB, Sweden), Trichoderma stromaticum TRICOVAB® (C.E.P.L.A.C., Brazil), Trichoderma virens GL-21 (SOILGARD®, Certis LLC, USA), Trichoderma virens G1-3, ATCC 57678, Trichoderma virens G1-21 (Thermo Trilogy Corporation, Wasco, Calif.), Trichoderma virens G1-3 and Bacillus amyloliquefaciens FZB2, Trichoderma virens G1-3 and Bacillus amyloliquefaciens NRRL B-50349, Trichoderma virens G1-3 and Bacillus amyloliquefaciens TJ1000, Trichoderma virens G1-21 and Bacillus amyloliquefaciens FZB24, Trichoderma virens G1-21 and Bacillus amyloliquefaciens NRRL B-50349, Trichoderma virens G1-21 and Bacillus amyloliquefaciens TJ1000, Trichoderma viride TRIECO® (Ecosense Labs. (India) Pvt. Ltd., Indien, BIO-CURE® F from T. Stanes & Co. Ltd., Indien), Trichoderma viride TV1 (Agribiotec srl, Italy), Trichoderma viride ICC080, and/or Ulocladiurn oudemansii HRU3 (BOTRY-ZEN®, Botry-Zen Ltd, NZ)), and combinations thereof.

Compositions in some embodiments may comprise one or more biologically active ingredients. Non-limiting examples of biologically active ingredients include plant growth regulators, plant signal molecules, growth enhancers, microbial stimulating molecules, biomolecules, soil amendments, nutrients, plant nutrient enhancers, etc., such as lipo-chitooligosaccharides (LCO), chitooligosaccharides (CO), chitinous compounds, flavonoids, jasmonic acid or derivatives thereof (e.g., jasmonates), cytokinins, auxins, gibberellins, absiscic acid, ethylene, brassinosteroids, salicylates, macro- and micronutrients, linoleic acid or derivatives thereof, linolenic acid or derivatives thereof, karrikins, etc.) and beneficial microorganisms (e.g., Rhizobium spp., Bradyrhizobium spp., Sinorhizobium spp., Azorhizobium spp., Glomus spp., Gigaspora spp., Hymenoscyphous spp., Oidiodendron spp., Laccaria spp., Pisolithus spp., Rhizopogon spp., Scleroderma spp., Rhizoctonia spp., Acinetobacter spp., Arthrobacter spp, Arthrobotrys spp., Aspergillus spp., Azospirillum spp, Bacillus spp, Burkholderia spp., Candida spp., Chryseomonas spp., Enterobacter spp., Eupenicillium spp., Exiguobacterium spp., Klebsiella spp., Kluyvera spp., Microbacterium spp., Mucor spp., Paecilomyces spp., Paenibacillus spp., Penicillium spp., Pseudomonas spp., Serratia spp., Stenotrophomonas spp., Streptomyces spp., Streptosporangium spp., Swaminathania spp., Thiobacillus spp., Torulospora spp., Vibrio spp., Xanthobacter spp., Xanthomonas spp., etc.), and combinations thereof.

Compositions in some embodiments may comprise one or more lipo-chitooligosaccharides (LCOs), chitooligosaccharides (COs), and/or chitinous compounds. LCOs, sometimes referred to as symbiotic nodulation (Nod) signals (or Nod factors) or as Myc factors, consist of an oligosaccharide backbone of β-1,4-linked N-acetyl-D-glucosamine (“GlcNAc”) residues with an N-linked fatty acyl chain condensed at the non-reducing end. As understood in the art, LCOs differ in the number of GlcNAc residues in the backbone, in the length and degree of saturation of the fatty acyl chain and in the substitutions of reducing and non-reducing sugar residues. See, e.g., Denarie et al., Ann. Rev. Biochem. 65:503 (1996); Diaz et al., Mol. Plant-Microbe Interactions 13:268 (2000); Hungria et al., Soil Biol. Biochem. 29:819 (1997); Hamel et al., Planta 232:787 (2010); and Prome et al., Pure & Appl. Chem. 70(1):55 (1998), the contents and disclosures of which are incorporated herein by reference.

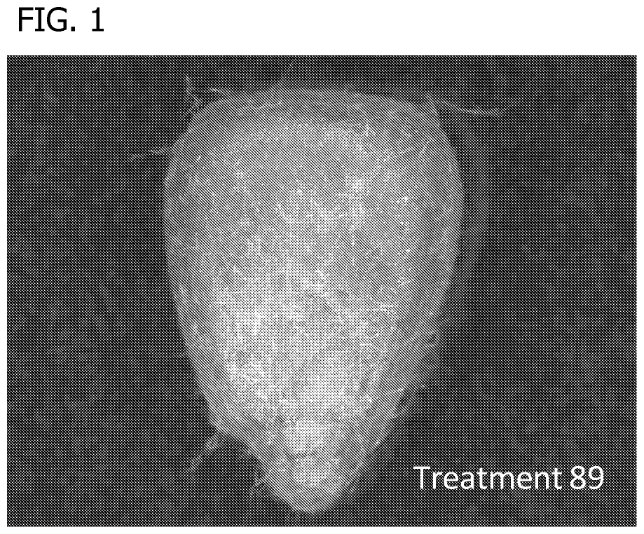

LCOs may be synthetic or obtained from any suitable source. See, e.g., WO 2005/063784, WO 2007/117500 and WO 2008/071674, the contents and disclosures of which are incorporated herein by reference. In some aspects, a synthetic LCO may have the basic structure of a naturally occurring LCO but contains one or more modifications or substitutions, such as those described in Spaink, Crit. Rev. Plant Sci. 54:257 (2000). LCOs and precursors for the construction of LCOs (e.g., COs, which may themselves be useful as a biologically active ingredient) can be synthesized by genetically engineered organisms. See, e.g., Samain et al., Carbohydrate Res. 302:35 (1997); Cottaz et al., Meth. Eng. 7(4):311 (2005); and Samain et al., J. Biotechnol. 72:33 (1999) (e.g., FIG. 1 therein, which shows structures of COs that can be made recombinantly in E. coli harboring different combinations of genes nodBCHL), the contents and disclosures of which are incorporated herein by reference.

LCOs (and derivatives thereof) may be included or utilized in the compositions described herein in various forms of purity and can be used alone or in the form of a culture of LCO-producing bacteria or fungi. For example, OPTIMIZE® (commercially available from Monsanto Company (St. Louis, Mo.)) contains a culture of Bradyrhizobium japonicum that produces LCO. Methods to provide substantially pure LCOs include removing the microbial cells from a mixture of LCOs and the microbe, or continuing to isolate and purify the LCO molecules through LCO solvent phase separation followed by HPLC chromatography as described, for example, in U.S. Pat. No. 5,549,718. Purification can be enhanced by repeated HPLC and the purified LCO molecules can be freeze-dried for long-term storage. According to some embodiments, the LCO(s) included in compositions of the present disclosure is/are at least 0.1%, 0.5%, 1%, 2%, 3%, 4%, 5%, 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, 99% or 100% pure. Compositions and methods in some embodiments may comprise analogues, derivatives, hydrates, isomers, salts and/or solvates of LCOs. LCOs may be incorporated into compositions of the present disclosure in any suitable amount(s)/concentration(s). For example, compositions of the present disclosure comprise about 1×10⁻²⁰ M to about 1×10⁻¹ M LCO(s). For example, compositions of the present disclosure can comprise about 1×10⁻²⁰ M, 1×10⁻¹⁹ M, 1×10⁻¹⁸ M, 1×10⁻¹⁷ M, 1×10⁻¹⁶ M, 1×10⁻¹⁵ M, 1×10⁻¹⁴ M, 1×10⁻¹³ M, 1×10⁻¹² M, 1×10⁻¹¹ M, 1×10⁻¹° M, 1×10⁻⁹ M, 1×10⁻⁸ M, 1×10⁻⁷ M, 1×10⁻⁶ M, 1×10⁻⁵ M, 1×10⁻⁴ M, 1×10⁻³ M, 1×10⁻² M, 1×10⁻¹ M of one or more LCOs. In an aspect, the LCO concentration is 1×10⁻¹⁴ M to 1×10⁻⁵ M, 1×10⁻¹² M to 1×10⁻⁶ M, or 1×10⁻¹⁰ M to 1×10⁻⁷ M. In an aspect, the LCO concentration is 1×10⁻¹⁴ M to 1×10⁻⁵ M, 1×10⁻¹² M to 1×10⁻⁶ M, or 1×10⁻¹⁰ M to 1×10⁻⁷ M. The amount/concentration of LCO may be an amount effective to impart a positive trait or benefit to a plant, such as to enhance the disease resistance, growth and/or yield of the plant to which the composition is applied. According to some embodiments, the LCO amount/concentration is not effective to enhance the yield of the plant without beneficial contributions from one or more other constituents of the composition, such as CO and/or one or more pesticides.

Compositions in some embodiments may comprise any suitable COs, perhaps in combination with one or more LCOs. COs differ from LCOs in that they lack the pendant fatty acid chain that is characteristic of LCOs. COs, sometimes referred to as N-acetylchitooligosaccharides, are also composed of GlcNAc residues but have side chain decorations that make them different from chitin molecules [(C₈H₁₃NO₅)ₙ, CAS No. 1398-61-4] and chitosan molecules [(C₅H₁₁NO₄)ₙ, CAS No. 9012-76-4]. See, e.g., D'Haeze et al., Glycobiol. 12(6):79R (2002); Demont-Caulet et al., Plant Physiol. 120(1):83 (1999); Hanel et al., Planta 232:787 (2010); Muller et al., Plant Physiol. 124:733 (2000); Robina et al., Tetrahedron 58:521-530 (2002); Rouge et al., Docking of Chitin Oligomers and Nod Factors on Lectin Domains of the LysM-RLK Receptors in the Medicago-Rhizobium Symbiosis, in The Molecular Immunology of Complex Carbohydrates-3 (Springer Science, 2011); Van der Holst et al., Curr. Opin. Struc. Biol. 11:608 (2001); and Wan et al., Plant Cell 21:1053 (2009), the contents and disclosures of which are incorporated by reference. COs may be obtained from any suitable source. For example, the CO may be derived from an LCO. For example, in an aspect, compositions comprise one or more COs derived from an LCO obtained (i.e., isolated and/or purified) from a strain of Azorhizobium, Bradyrhizobium (e.g., B. japonicum), Mesorhizobium, Rhizobium (e.g., R. leguminosarum), Sinorhizobium (e.g., S. meliloti), or mycorhizzal fungi (e.g., Glomus intraradicus). Alternatively, the CO may be synthetic. Methods for the preparation of recombinant COs are known in the art. See, e.g., Cottaz et al., Meth. Eng. 7(4):311 (2005); Samain et al., Carbohydrate Res. 302:35 (1997); and Samain et al., J. Biotechnol. 72:33 (1999), the contents and disclosures of which are incorporated herein by reference.

COs (and derivatives thereof) may be included or utilized in the compositions described herein in various forms of purity and can be used alone or in the form of a culture of CO-producing bacteria or fungi. According to some embodiments, the CO(s) included in compositions may be at least 0.1%, 0.5%, 1%, 2%, 3%, 4%, 5%, 6%, 7%, 8%, 9%, 10%, 15%, 20%, 30%, 40%, 50%, 60%, 70%, 75%, 80%, 85%, 90%, 91%, 92%, 93%, 94%, 95%, 96%, 97%, 98%, 99%, 99.5% or more pure. It is to be understood that compositions and methods of the present disclosure can comprise hydrates, isomers, salts and/or solvates of COs. COs in some embodiments may be incorporated into compositions in any suitable amount(s)/concentration(s). For example, compositions in some embodimentsmay comprise about 1×10⁻²⁰ M to about 1×10⁻¹ M COs, such as about 1×10⁻²⁰ M, 1×10⁻¹⁹ M, 1×10⁻¹⁸ M, 1×10⁻¹⁷ M, 1×10⁻¹⁶ M, 1×10⁻¹⁵ M, 1×10⁻¹⁴ M, 1×10⁻¹³ M, 1×10⁻¹² M, 1×10⁻¹¹ M, 1×10⁻¹⁰ M, 1×10⁻⁹ M, 1×10⁻⁸ M, 1×10⁻⁷ M, 1×10⁻⁶ M, 1×10⁻⁵ M, 1×10⁻⁴ M, 1×10⁻³ M, 1×10⁻² M, or 1×10⁻¹ M of one or more COs. For example, the CO concentration may be 1×10⁻¹⁴ M to 1×10⁻⁵ M, 1×10⁻¹² M to 1×10⁻⁶ M, or 1×10⁻¹⁰ M to 1×10⁻⁷ M. The amount/concentration of CO may be an amount effective to impart or confer a positive trait or benefit to a plant, such as to enhance the soil microbial environment, nutrient uptake, or increase the growth and/or yield of the plant to which the composition is applied. Compositions in some embodiments may comprise one or more suitable chitinous compounds, such as, for example, chitin (IUPAC: N-[5-[[3-acetylamino-4,5-dihydroxy-6-(hydroxymethyl)oxan-2yl]methoxymethyl]-2-[[5-acetylamino-4,6-dihydroxy-2-(hydroxymethyl)oxan-3-yI]methoxymethyl]-4-hydroxy-6-(hydroxymethyl)oxan-3-ys]ethanamide), chitosan (IUPAC: 5-amino-6-[5-amino-6-[5-amino-4,6-dihydroxy-2(hydroxymethyl)oxan-3-yl]oxy-4-hydroxy-2-(hydroxymethyl)oxan-3-yl]oxy-2(hydroxymethyl)oxane-3,4-diol), and isomers, salts and solvates thereof.

Chitins and chitosans, which are major components of the cell walls of fungi and the exoskeletons of insects and crustaceans, are composed of GlcNAc residues. Chitins and chitosans may be obtained commercially or prepared from insects, crustacean shells, or fungal cell walls. Methods for the preparation of chitin and chitosan are known in the art. See, e.g., U.S. Pat. No. 4,536,207 (preparation from crustacean shells) and U.S. Pat. No. 5,965,545 (preparation from crab shells and hydrolysis of commercial chitosan); and Pochanavanich et al., Lett. Appl. Microbiol. 35:17 (2002) (preparation from fungal cell walls).

Deacetylated chitins and chitosans may be obtained that range from less than 35% to greater than 90% deacetylation and cover a broad spectrum of molecular weights, e.g., low molecular weight chitosan oligomers of less than 15 kD and chitin oligomers of 0.5 to 2 kD; “practical grade” chitosan with a molecular weight of about 15 kD; and high molecular weight chitosan of up to 70 kD. Chitin and chitosan compositions formulated for seed treatment are commercially available. Commercial products include, for example, ELEXA® (Plant Defense Boosters, Inc.) and BEYOND™ (Agrihouse, Inc.).

Compositions in some embodiments may comprise one or more suitable flavonoids, including, but not limited to, anthocyanidins, anthoxanthins, chalcones, coumarins, flavanones, flavanonols, flavans and isoflavonoids, as well as analogues, derivatives, hydrates, isomers, polymers, salts and solvates thereof. Flavonoids are phenolic compounds having the general structure of two aromatic rings connected by a three-carbon bridge. Classes of flavonoids are known in the art. See, e.g., Jain et al., J. Plant Biochem. & Biotechnol. 11:1 (2002); and Shaw et al., Environ. Microbiol. 11:1867 (2006), the contents and disclosures of which are incorporated herein by reference. Several flavonoid compounds are commercially available. Flavonoid compounds may be isolated from plants or seeds, e.g., as described in U.S. Pat. Nos. 5,702,752; 5,990,291; and 6,146,668. Flavonoid compounds may also be produced by genetically engineered organisms, such as yeast, See, e.g. Ralston et al., Plant Physiol. 137:1375 (2005).

According to embodiments, compositions may comprise one or more flavanones, such as one or more of butin, eriodictyol, hesperetin, hesperidin, homoeriodictyol, isosakuranetin, naringenin, naringin, pinocembrin, poncirin, sakuranetin, sakuranin, and/or sterubin, one or more flavanonols, such as dihydrokaempferol and/or taxifolin, one or more flavans, such as one or more flavan-3-ols (e.g., catechin (C), catechin 3-gallate (Cg), epicatechins (EC), epigallocatechin (EGC) epicatechin 3-gallate (ECg), epigallcatechin 3-gallate (EGCg), epiafzelechin, fisetinidol, gallocatechin (GC), gallcatechin 3-gallate (GCg), guibourtinidol, mesquitol, robinetinidol, theaflavin-3-gallate, theaflavin-3′-gallate, theflavin-3,3′-digallate, thearubigin), flavan-4-ols (e.g., apiforol and/or luteoforol) and/or flavan-3,4-diols (e.g., leucocyanidin, leucodelphinidin, leucofisetinidin, leucomalvidin, luecopelargonidin, leucopeonidin, leucorobinetinidin, melacacidin and/or teracacidin) and/or dimers, trimers, oligomers and/or polymers thereof (e.g., one or more proanthocyanidins), one or more isoflavonoids, such as one or more isoflavones or flavonoid derivatives (e.g, biochanin A, daidzein, formononetin, genistein and/or glycitein), isoflavanes (e.g., equol, ionchocarpane and/or laxifloorane), isoflavandiols, isoflavenes (e.g., glabrene, haginin D and/or 2-methoxyjudaicin), coumestans (e.g., coumestrol, plicadin and/or wedelolactone), pterocarpans, roetonoids, neoflavonoids (e.g, calophyllolide, coutareagenin, dalbergichromene, dalbergin, nivetin), and/or pterocarpans (e.g., bitucarpin A, bitucarpin B, erybraedin A, erybraedin B, erythrabyssin II, erthyrabissin-1, erycristagallin, glycinol, glyceollidins, glyceollins, glycyrrhizol, maackiain, medicarpin, morisianine, orientanol, phaseolin, pisatin, striatine, trifolirhizin), and combinations thereof. Flavonoids and their derivatives may be included in compositions in any suitable form, including, but not limited to, polymorphic and crystalline forms. Flavonoids may be included in compositions in any suitable amount(s) or concentration(s). The amount/concentration of a flavonoid(s) may be an amount effective to impart a benefit to a plant, which may be indirectly through activity on soil microorganisms or other means, such as to enhance plant nutrition and/or yield. According to some embodiments, a flavonoid amount/concentration may not be effective to enhance the nutrition or yield of the plant without the beneficial contributions from one or more other ingredients of the composition, such as LCO, CO, and/or one or more pesticides.

Compositions in some embodiments may comprise one or more suitable non-flavonoid nod-gene inducer(s), including, but not limited to, jasmonic acid ([1R-[1α,2β(Z)]]-3-oxo-2-(pentenyl)cyclopentaneacetic acid; JA), linoleic acid ((Z,Z)-9,12-Octadecadienoic acid) and/or linolenic acid ((Z,Z,Z)-9,12,15-octadecatrienoic acid), and analogues, derivatives, hydrates, isomers, polymers, salts and solvates thereof. Jasmonic acid and its methyl ester, methyl jasmonate (MeJA), collectively known as jasmonates, are octadecanoid-based compounds that occur naturally in some plants (e.g., wheat), fungi (e.g., Botryodiplodia theobromae, Gibberella fujikuroi), yeast (e.g., Saccharomyces cerevisiae) and bacteria (e.g., Escherichia coli). Linoleic acid and linolenic acid may be produced in the course of the biosynthesis of jasmonic acid. Jasmonates, linoleic acid and linolenic acid (and their derivatives) are reported to be inducers of nod gene expression or LCO production by rhizobacteria. See, e.g., Mabood et al. Plant Physiol. Biochem. 44(11):759 (2006); Mabood et al., Agr. J. 98(2):289 (2006); Mabood et al., Field Crops Res. 95(2-3):412 (2006); and Mabood & Smith, Linoleic and linolenic acid induce the expression of nod genes in Bradyrhizobium japonicum USDA 3, Plant Biol. (2001).

Derivatives of jasmonic acid, linoleic acid, and linolenic acid that may be included or used in compositions in some embodiments include esters, amides, glycosides and salts thereof. Representative esters are compounds in which the carboxyl group of linoleic acid, linolenic acid, or jasmonic acid has been replaced with a —COR group, where R is an —OR¹ group, in which R¹ is: an alkyl group, such as a C₁-C₈ unbranched or branched alkyl group, e.g., a methyl, ethyl or propyl group; an alkenyl group, such as a C₂-C₈ unbranched or branched alkenyl group; an alkynyl group, such as a C₂-C₈ unbranched or branched alkynyl group; an aryl group having, for example, 6 to 10 carbon atoms; or a heteroaryl group having, for example, 4 to 9 carbon atoms, wherein the heteroatoms in the heteroaryl group can be, for example, N, O, P, or S. Representative amides are compounds in which the carboxyl group of linoleic acid, linolenic acid, or jasmonic acid has been replaced with a —COR group, where R is an NR²R³ group, in which R² and R³ are each independently: a hydrogen; an alkyl group, such as a C₁-C₈ unbranched or branched alkyl group, e.g., a methyl, ethyl or propyl group; an alkenyl group, such as a C₂-C₈ unbranched or branched alkenyl group; an alkynyl group, such as a C₂-C₈ unbranched or branched alkynyl group; an aryl group having, for example, 6 to 10 carbon atoms; or a heteroaryl group having, for example, 4 to 9 carbon atoms, wherein the heteroatoms in the heteroaryl group can be, for example, N, O, P, or S. Esters may be prepared by known methods, such as acid-catalyzed nucleophilic addition, wherein the carboxylic acid is reacted with an alcohol in the presence of a catalytic amount of a mineral acid. Amides may also be prepared by known methods, such as by reacting the carboxylic acid with the appropriate amine in the presence of a coupling agent, such as dicyclohexyl carbodiimide (DCC), under neutral conditions. Suitable salts of linoleic acid, linolenic acid and jasmonic acid include, for example, base addition salts. The bases that may be used as reagents to prepare metabolically acceptable base salts of these compounds include those derived from cations such as alkali metal cations (e.g., potassium and sodium) and alkaline earth metal cations (e.g., calcium and magnesium). These salts may be readily prepared by mixing a solution of linoleic acid, linolenic acid, or jasmonic acid with a solution of the base. The salts may be precipitated from solution and collected by filtration, or may be recovered by other means such as by evaporation of the solvent.

Non-flavonoid nod-gene inducers may be incorporated into compositions in any suitable amount(s)/concentration(s). For example, the amount/concentration of non-flavonoid nod-gene inducers may be an amount effective to impart or confer a positive trait or benefit to a plant, such as to enhance the disease resistance, growth and/or yield of the plant to which the composition is applied. According to some embodiments, the amount/concentration of non-flavonoid nod-gene inducers may not be effective to enhance the growth and/or yield of the plant without beneficial contributions from one or more other ingredients of the composition, such as a LCO, CO and/or one or more pesticides.

Compositions in some embodiments may comprise karrakins, including but not limited to 2H-furo[2,3-c]pyran-2-ones, as well as analogues, derivatives, hydrates, isomers, polymers, salts and solvates thereof. Examples of biologically acceptable salts of karrakins include acid addition salts formed with biologically acceptable acids, examples of which include hydrochloride, hydrobromide, sulphate or bisulphate, phosphate or hydrogen phosphate, acetate, benzoate, succinate, fumarate, maleate, lactate, citrate, tartrate, gluconate; methanesulphonate, benzenesulphonate and p-toluenesulphonic acid. Additional biologically acceptable metal salts may include alkali metal salts, with bases, examples of which include the sodium and potassium salts. Karrakins may be incorporated into the compositions described herein in any suitable amount(s) or concentration(s). For example, the amount/concentration of a karrakin may be an amount or concentration effective to impart or confer a positive trait or benefit to a plant, such as to enhance the disease resistance, growth and/or yield of the plant to which the composition is applied. In an aspect, a karrakin amount/concentration may not be effective to enhance the disease resistance, growth and/or yield of the plant without beneficial contributions from one or more other ingredients of the composition, such as a LCO, CO and/or one or more pesticides.

Additional Composition Components

In addition to the one or more optional additional active ingredients in combination with the solid compound as described herein, various adjuvants and excipients known in the art may optionally be utilized in the seed treatment mixture. For example, and without limitation, a composition in the form of an aqueous suspension concentrate may further optionally contain an antifreeze agent, thickener, antifoam agent, buffers, one or more solvents, rheology modifying agents, and/or dispersing or wetting agents. Discussion of these optional components as well as non-limiting commercially available examples of such components can be found in U.S. Patent Application Publication Nos. 2014/0187419 A1 and 2015/0342189 A1, the contents of which are expressly incorporated herein by reference.

Treated Seeds

In another embodiment, a seed is treated with a seed treatment mixture as described herein, including for example a solid compound such as a 3,5-disubstituted 1,2,4-oxadiazole, a sublimation inhibitor, and optionally one or more additional component as described herein. Typically, the seed has been treated with the seed treatment mixture using one of the seed treatment methods set forth above. The seed may be of any plant species, as described above.

In one embodiment, the treated seeds comprise a nematicidal compound in an amount of at least about 0.05 mg/seed, more typically from about 0.05 to about 1 mg/seed, and even more typically from about 0.05 to about 0.5 mg/seed.

### EXAMPLES

The following examples are to be considered as merely illustrative, and are not intended to limit the scope of this invention.

### Example 1

A study was conducted to evaluate whether certain compounds, when used in combination with a nematicidal composition comprising tioxazafen (i.e., 3-phenyl-5-(2-thienyl)-1,2,4-oxadiazole), are able to reduce or eliminate the growth of tioxazafen crystals on the surface of corn seeds.

Corn seeds were treated with a seed treatment mixture comprising a commercially available formulation containing fungicides and an insecticide. In addition, with the exception of the control, the corn seeds were treated with tioxazafen applied at a rate of 0.5 mg/seed. In some treatments, a styrene acrylic copolymer (JONCRYL 62 or JONCRYL 63) was included. In some treatments, a lignin sulfonate (HYACT) was included. In some treatments, a non-ionic surfactant (BRIJ S20 or P-L101) was included. Additionally, in some treatments “S20 water” was prepared by dissolving or dispersing 4.0 g of BRIJ S20 in DI water (196.0 g), and was used in place of regular DI water. The seed treatments are summarized in Table 1 below.

TABLE 1

| Treatment | | | |
|---|---|---|---|
| No | Treatment | Surfactant/Additive | Water |
| 89 | Tioxazafen and | BRIJ S20 4% | S20 water |
| | Surfactant | | |
| 90 | Tioxazafen and | BRIJ S20 2.0% + | S20 water |
| | Surfactants | P-L101 2.0% | |
| 91 | Tioxazafen and | BRIJ CS20-SO-(MH) | S20 water |
| | Surfactants | 2% + P-L101 2% | |
| 92 | Tioxazafen and | HYACT | S20 water |
| | Lignin Sulfonate | | |
| 93 | Tioxazafen and | BRIJ S20 4% | Regular |
| | Surfactant | | |
| 94 | Tioxazafen and | BRIJ S20 2.0% + | Regular |
| | Surfactants | P-L101 2.0% | |
| 95 | Tioxazafen and | BRIJ CS20-SO-(MH) | Regular |
| | Surfactants | 2% + P-L101 2% | |
| 96 | Tioxazafen and | HYACT | Regular |
| | Lignin Sulfonate | | |
| 97 | Tioxazafen | N/A | S20 water |
| 98 | Tioxazafen | N/A | Regular |
| 98a | Tioxazafen and | JONCRYL 62 | Regular |
| | Styrene Acrylic | | |
| | Copolymer | | |
| 98b | Tioxazafen and | JONCRYL 63 | Regular |
| | Styrene Acrylic | | |
| | Copolymer | | |
| 99 | No Tioxazafen | N/A | Regular |
| | (Control) | | |

For treatment 99, no tioxazafen or additional surfactants or polymer were applied, which provided a good control. For treatments 97 and 98, only the seed treatment mixture comprising a commercially available formulation containing fungicides and an insecticide and tioxazafen (at a rate of 0.5 mg/seed), with no additional surfactants or polymer, was applied. For treatments 92 and 96, in addition to the seed treatment mixture comprising a commercially available formulation containing fungicides and an insecticide and tioxazafen (applied at a rate of 0.5 mg/seed), HYACT lignin sulfonate was added. For treatments 98a and 98b, in addition to the seed treatment mixture comprising a commercially available formulation containing fungicides and an insecticide and tioxazafen (applied at a rate of 0.5 mg/seed), JONCRYL 62 or JONCRYL 63 styrene acrylic copolymer, respectively, was added.

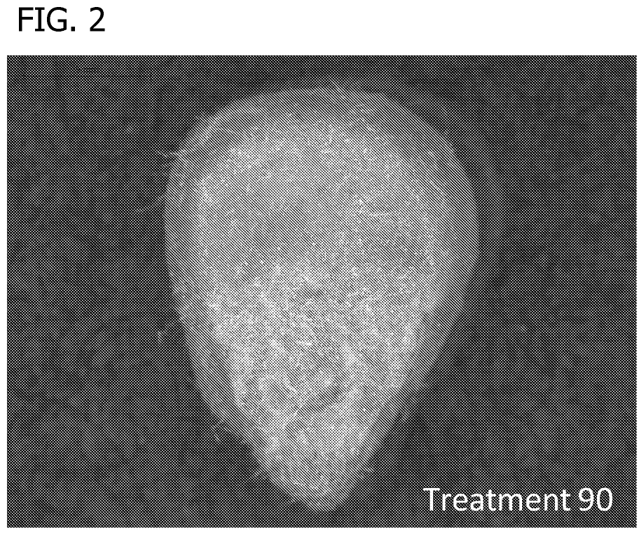

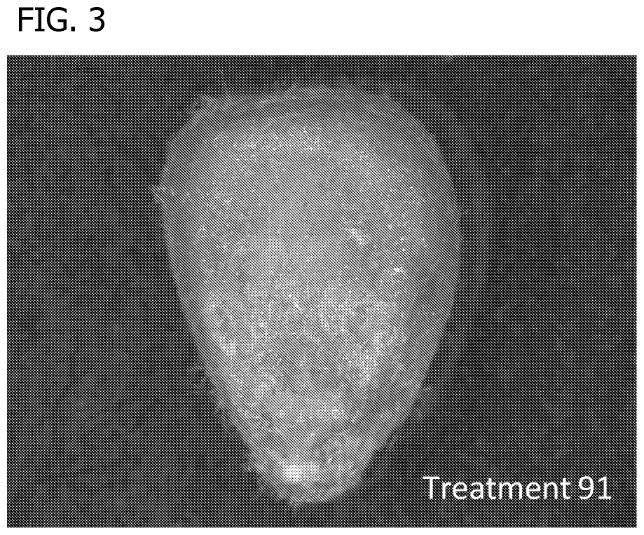

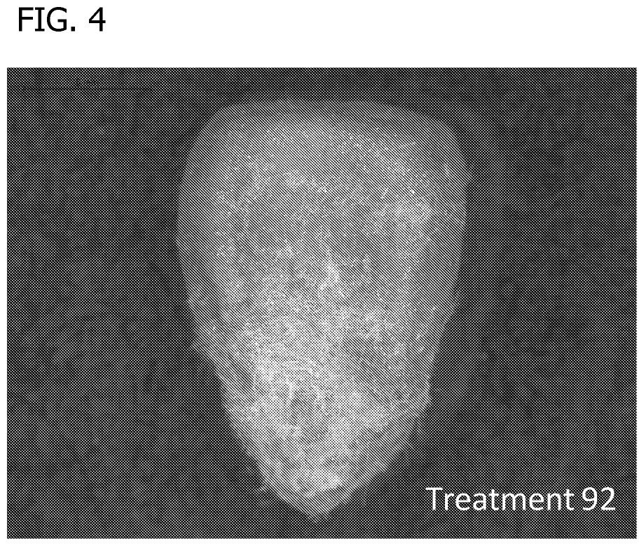

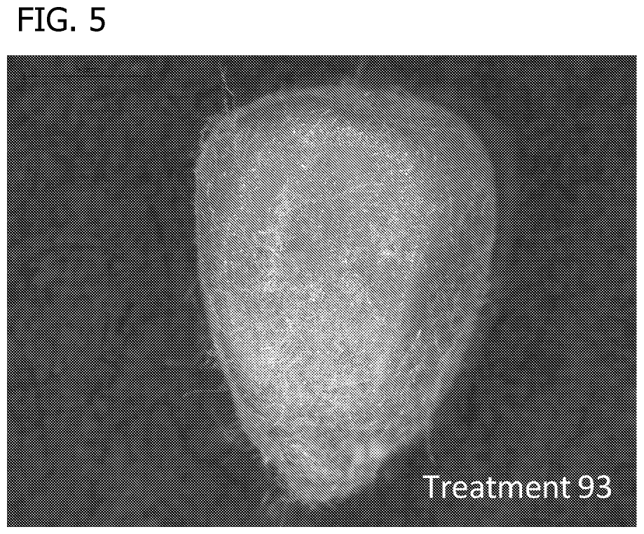

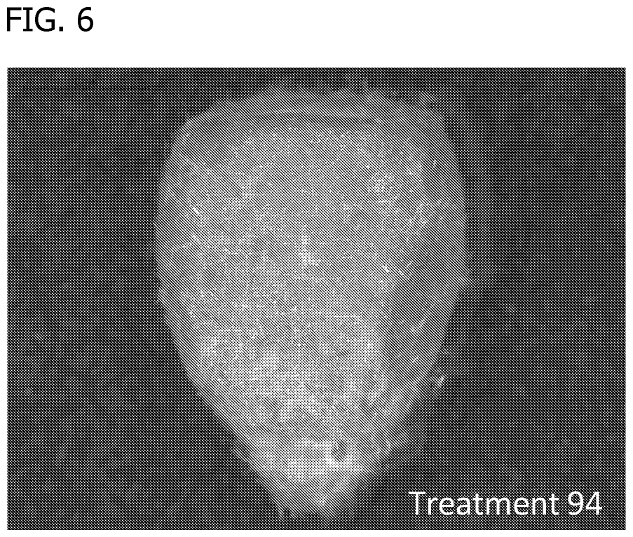

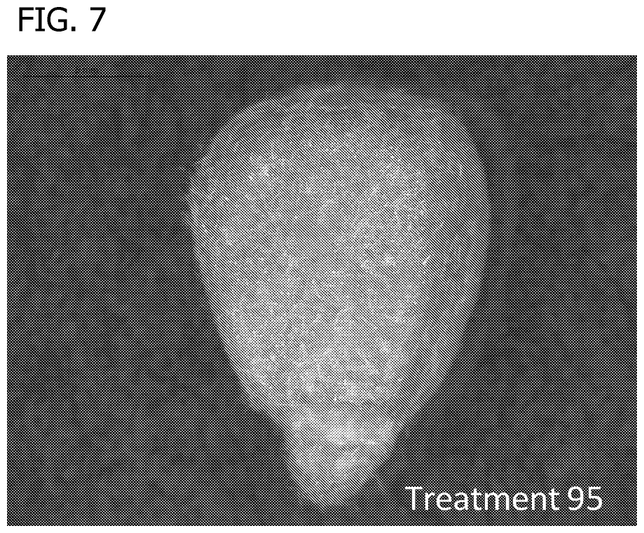

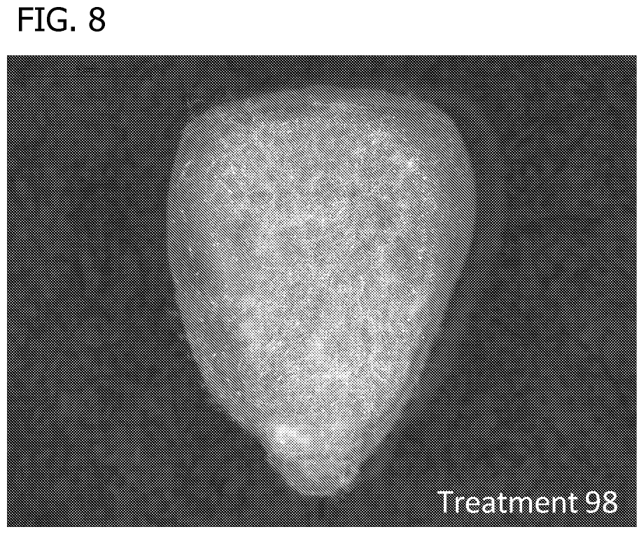

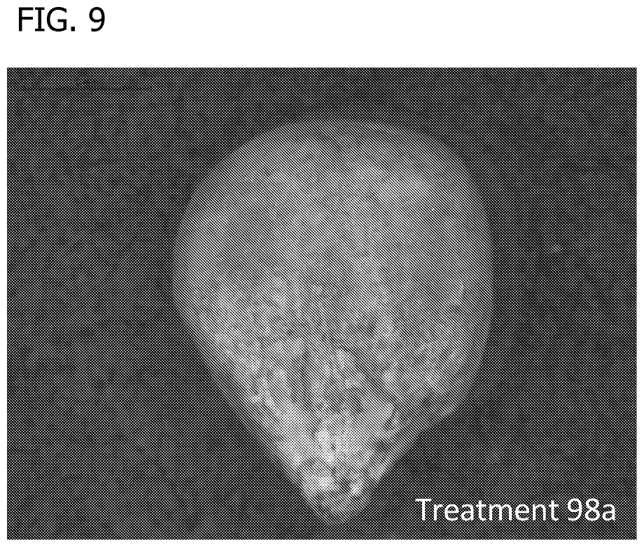

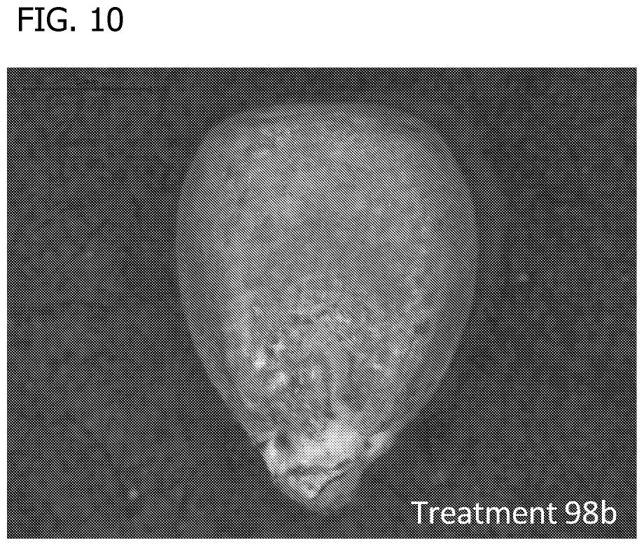

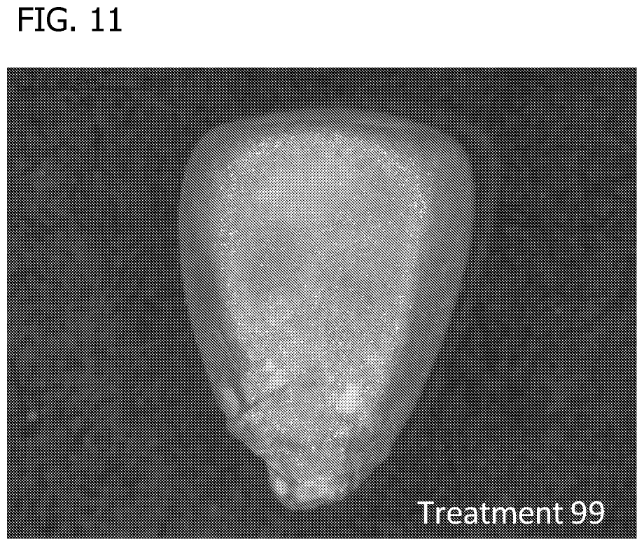

After the treated seeds were stored in a 35° C. vacuum oven for 60 days, images of the seeds were taken under a microscope. Images of treated seeds prepared in this example are depicted in FIGS. 1-11. One can see that no white needle crystals of tioxazafen appeared on corn seeds prepared with treatments 98a, 98b or 99 and the appearance of white needle crystals of tioxazafen on the seed prepared with treatment 92 was reduced as compared to some other treatments. White crystals of tioxazafen appeared on other treated corn seeds.

### Example 2

A study was conducted to evaluate whether METASPERSE 500L, when used in combination with a nematicidal formulation comprising tioxazafen, was able to reduce or eliminate the growth of tioxazafen crystals on the surface of corn seeds.

Corn seeds were treated with a seed treatment mixture comprising a commercially available formulation containing fungicides and an insecticide, tioxazafen applied at a rate of 0.5 mg/seed, and the METASPERSE 500L sublimation inhibitor. The treatment list and the information of the seed treatments are presented in Table 2 below.

After the treated seeds were stored in a 35° C. vacuum oven for 90 days, images of the seeds were taken under a microscope. The images of the seeds with treatments 10 to 14 showed that the amount of white crystals of tioxazafen were reduced dramatically when compared with the images of treatments 2 and 3. No white crystal growth was observed on the treated seeds from control treatment 1, in which the seed treatment mixture contained only the commercially available formulation containing fungicides and an insecticide was used and no tioxazafen formulation was applied.

The results from this experiment demonstrate that METASPERSE 500 L can prevent or reduce the formation of tioxazafen crystals on treated corn seeds when used as a sublimation inhibitor.

TABLE 2

| | | ATLOX |
|---|---|---|
| Treatment # | Tioxazafen | METASPERSE 500 L |
| 1 | — | — |
| 2 | 0.5 mg/seed | — |
| 3 | 0.5 mg/seed | — |
| 4 | 0.5 mg/seed | — |
| 5 | 0.5 mg/seed | — |
| 6 | 0.5 mg/seed | — |
| 7 | 0.5 mg/seed | — |
| 8 | 0.5 mg/seed | — |
| 9 | 0.5 mg/seed | — |
| 10 | 0.5 mg/seed | 1.75 mL/kg (3.0 fl oz/cwt) |
| 11 | 0.5 mg/seed | 1.16 mL/kg (2.0 fl oz/cwt) |
| 12 | 0.5 mg/seed | 1.75 mL/kg (3.0 fl oz/cwt) |
| 13 | 0.5 mg/seed | 1.75 mL/kg (3.0 fl oz/cwt) |
| 14 | 0.5 mg/seed | 1.75 mL/kg (3.0 fl oz/cwt) |
| 15 | 0.5 mg/seed | 1.75 mL/kg (3.0 fl oz/cwt) |
| 16 | 0.5 mg/seed | 1.75 mL/kg (3.0 fl oz/cwt) |
| 17 | 0.5 mg/seed | 1.75 mL/kg (3.0 fl oz/cwt) |
| 18 | 0.5 mg/seed | 1.75 mL/kg (3.0 fl oz/cwt) |

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and the associated drawings shall be interpreted as illustrative and not in a limiting sense.

What is claimed is:

1. A method of preparing a treated seed, the method comprising:
mixing a nematicidal composition comprising a 3,5-disubstituted 1,2,4-oxadiazole with a sublimation inhibitor to form a seed treatment mixture; and
applying the seed treatment mixture to a seed.

2. A method of preparing a treated seed, the method comprising:
applying a first seed treatment mixture comprising a nematicidal composition comprising a 3,5-disubstituted 1,2,4-oxadiazole to a seed; and
applying a second seed treatment mixture comprising a sublimation inhibitor to the seed to form a treated seed.

3. A seed treatment mixture comprising a 3,5-disubstituted 1,2,4-oxadiazole and a sublimation inhibitor.

4. The seed treatment mixture of claim 3 wherein the concentration of the 3,5-disubstituted 1,2,4-oxadiazole in the seed treatment mixture is no greater than about 25% by weight, no greater than about 20% by weight, or no greater than about 15% by weight.

5. The seed treatment mixture of claim 3 or claim 4 wherein the concentration of the sublimation inhibitor in the seed treatment mixture is at least about 5% by weight, at least about 10% by weight, at least about 15% by weight, or at least about 20% by weight.

6. A method of preparing a treated seed, the method comprising applying the seed treatment mixture of claim 4 or claim 5 to a seed.

7. The method or mixture of any one of claims 1 to 6 wherein the sublimation inhibitor comprises a polymer selected from the group consisting of acrylic polymers, vinyl polymers, alkyl naphthalene sulfonates, sulfonate condensates, lignin sulfonates and mixtures thereof.

8. The method or mixture of claim 7 wherein the sublimation inhibitor comprises an acrylic polymer.

9. The method or mixture of claim 8 wherein the sublimation inhibitor comprises a copolymer derived from acrylic acid and one or more additional monomers.

10. The method or mixture of claim 9 wherein the sublimation inhibitor comprises a copolymer selected from the group consisting of olefin acrylic copolymers, styrene acrylic copolymers, and mixtures thereof.

11. The method or mixture of claim 8 wherein the sublimation inhibitor comprises a poly(methyl methacrylate) polymer.

12. The method or mixture of claim 7 wherein the sublimation inhibitor comprises a vinyl polymer.

13. The method or mixture of claim 12 wherein the vinyl polymer comprises a polyvinyl acetate polyvinyl pyrrolidone copolymer.

14. The method or mixture of claim 7 wherein the sublimation inhibitor comprises a sulfonate condensate.

15. The method or mixture of claim 14 wherein the sulfonate condensate comprises a polymer selected from the group consisting of naphthalene sulfonate condensates, sodium phenol sulfonate condensates, and mixtures thereof.

16. The method or mixture of claim 15 wherein the sulfonate condensate comprises a sodium phenol sulfonate condensate.

17. The method or mixture of claim 7 wherein the sublimation inhibitor comprises an alkyl naphthalene sulfonate.

18. The method or mixture of claim 7 wherein the sublimation inhibitor comprises a lignin sulfonate.

19. The method or mixture of claim 18 wherein the lignin sulfonate comprises sodium lignosulfonate.

20. The method or mixture of any one of claims 7 to 19 wherein the sublimation inhibitor comprises an aromatic functional group in the polymer chain.

21. The method or mixture of any one of claims 1 to 20 wherein the 3,5-disubstituted 1,2,4-oxadiazole is a compound of Formula (I) or a salt thereof, 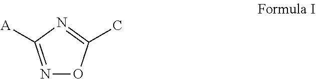
wherein,
A is selected from the group consisting of phenyl, pyridyl, pyrazyl, oxazolyl and isoxazolyl, each of which can be optionally independently substituted with one or more substituents selected from the group consisting of halogen, CF₃, CH₃, OCF₃, OCH₃, CN, and C(H)O; and
C is selected from the group consisting of thienyl, furanyl, oxazolyl and isoxazolyl, each of which can be optionally independently substituted with one or more substituents selected from the group consisting of F, Cl, CH₃, and OCF₃.

22. The method or mixture of claim 21 wherein the 3,5-disubstituted 1,2,4-oxadiazole is a compound of Formula (Ia) or a salt thereof, 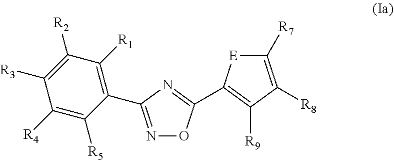
wherein,
R₁ and R₅ are independently selected from hydrogen, CH₃, F, Cl, Br, CF₃ and OCF₃;
R₂ and R₄ are independently selected from hydrogen, F, Cl, Br, and CF₃;
R₃ is selected from hydrogen, CH₃, CF₃, F, Cl, Br, OCF₃, OCH₃, CN, and C(H)O;
R₇ and R₈ are independently selected from hydrogen and F;
R₉ is selected from hydrogen, F, Cl, CH₃, and OCF₃; and
E is O or S.

23. The method or mixture of claim 22 wherein the 3,5-disubstituted 1,2,4-oxadiazole is a compound selected from the group consisting of 3-phenyl-5-(thiophen-2-yl)-1,2,4-oxadiazole, 3-(4-chlorophenyl)-5-(furan-2-yl)-1,2,4-oxadiazole, 3-(4-chloro-2-methylphenyl)-5-(furan-2-yl)-1,2,4-oxadiazole, and 5-(furan-2-yl)-3-phenyl-1,2,4-oxadiazole.

24. The method or mixture of claim 23 wherein the 3,5-disubstituted 1,2,4-oxadiazole is 3-phenyl-5-(thiophen-2-yl)-1,2,4-oxadiazole.

25. The method or mixture of claim 21 wherein the 3,5-disubstituted 1,2,4-oxadiazole is a compound of Formula (Ib) or a salt thereof, 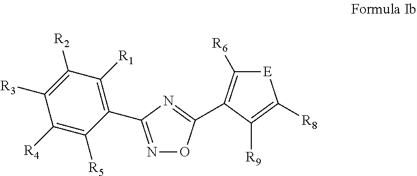
wherein,
R₁ and R₅ are independently selected from the group consisting of hydrogen, CH₃, F, Cl, Br, CF₃ and OCF₃;
R₂ and R₄ are independently selected from the group consisting of hydrogen, F, Cl, Br, and CF₃;
R₃ is selected from the group consisting of hydrogen, CH₃, CF₃, F, Cl, Br, OCF₃, OCH₃, CN, and C(H)O;
R₈ is selected from hydrogen and F;
R₆ and R₉ are independently selected from the group consisting of hydrogen, F, Cl, CH₃, and OCF₃; and
E is O or S.

26. The method or mixture of claim 25 wherein the 3,5-disubstituted 1,2,4-oxadiazole is a compound selected from the group consisting of 3-(4-bromophenyl)-5-(furan-3-yl)-1,2,4-oxadiazole and 3-(2,4-difluorophenyl)-5-(thiophen-3-yl)-1,2,4-oxadiazole.

27. The method or mixture of any one of claims 1 to 20 wherein the 3,5-disubstituted 1,2,4-oxadiazole is a compound of Formula (II) or a salt thereof, 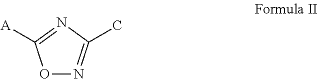
wherein,
A is selected from the group consisting of phenyl, pyridyl, pyrazyl, oxazolyl and isoxazolyl, each of which can be optionally independently substituted with one or more substituents selected from the group consisting of halogen, CF₃, CH₃, OCF₃, OCH₃, CN, and C(H)O; and
C is selected from the group consisting of thienyl, furanyl, oxazolyl and isoxazolyl, each of which can be optionally independently substituted with one or more with substituents selected from the group consisting of F, Cl, CH₃, and OCF₃.

28. The method or mixture of claim 27 wherein the 3,5-disubstituted 1,2,4-oxadiazole is a compound of Formula (IIa) or a salt thereof, 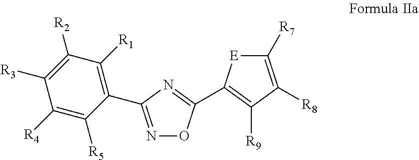
wherein,
R₁ and R₅ are independently selected from the group consisting of hydrogen, CH₃, F, Cl, Br, CF₃ and OCF₃;
R₂ and R₄ are independently selected from the group consisting of hydrogen, F, Cl, Br, and CF₃;
R₃ is selected from the group consisting of hydrogen, CH₃, CF₃, F, Cl, Br, OCF₃, OCH₃, CN, and C(H)O;
R₇ and R₈ are independently selected from hydrogen and F; R₉ is selected from the group consisting of hydrogen, F, Cl, CH₃, and OCF₃; and
E is O or S.

29. The method or mixture of claim 28 wherein the 3,5-disubstituted 1,2,4-oxadiazole is a compound selected from the group consisting of 3-(thiophen-2-yl)-5-(p-tolyl)-1,2,4-oxadiazole, 5-(3-chlorophenyl)-3-(thiophen-2-yl)-1,2,4-oxadiazole, and 5-(4-chloro-2-methylphenyl)-3-(furan-2-yl)-1,2,4-oxadiazole.

30. The method or mixture of claim 27 wherein the 3,5-disubstituted 1,2,4-oxadiazole is a compound of Formula (IIb) or a salt thereof, 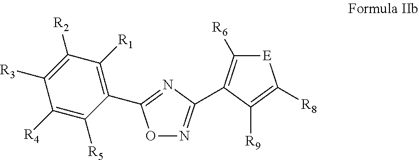
wherein,
R₁ and R₅ are independently selected from the group consisting of hydrogen, CH₃, F, Cl, Br, CF₃ and OCF₃;
R₂ and R₄ are independently selected from the group consisting of hydrogen, F, Cl, Br, and CF₃;
R₃ is selected from the group consisting of hydrogen, CH₃, CF₃, F, Cl, Br, OCF₃, OCH₃, CN, and C(H)O;
R₈ is selected from hydrogen and F;
R₆ and R₉ are independently selected from the group consisting of hydrogen, F, Cl, CH₃, and OCF₃; and
E is O or S.

31. The method or mixture of any one of claims 1 to 30 wherein the nematicidal composition or seed treatment mixture is in the form of an aqueous suspension concentrate.

32. The method or mixture of any one of claims 1 or 3 to 31 wherein the weight ratio of the sublimation inhibitor to the 3,5-disubstituted 1,2,4-oxadiazole in the seed treatment mixture is at least about 0.2:1, 0.25:1, at least about 0.3:1, at least about 0.4:1, or at least about 0.5:1.

33. The method or mixture of any one of claims 1 or 3 to 32 wherein the weight ratio of the sublimation inhibitor to the 3,5-disubstituted 1,2,4-oxadiazole in the seed treatment mixture is from about 0.2:1 to about 4:1, from about 0.2:1 to about 2:1, from about 0.2:1 to about 1:1, from about 0.25:1 to about 1:1, or from about 0.25:1 to about 0.75:1.

34. A treated seed prepared according to the method of any one of claims 1, 2, or 6 to 33.

35. A method of inhibiting the sublimation of a solid compound from the surface of a substrate, the method comprising:
coating the solid compound with a treatment composition comprising a sublimation inhibitor.

36. A method of inhibiting the sublimation of a solid compound from the surface of a substrate, the method comprising:
coating the solid compound with a treatment composition comprising a sublimation inhibitor, wherein the sublimation inhibitor comprises a polymer selected from the group consisting of acrylic polymers, vinyl polymers, alkyl naphthalene sulfonates, sulfonate condensates, lignin sulfonates and mixtures thereof.
